(19) United States
(12) Patent Application Publication
(10) Pub. No.: US 2026/0107043 A1
(43) Pub. Date: Apr. 16, 2026

(54) PROGRAM, INFORMATION PROCESSING METHOD, AND SERVER

(71) Applicant: LY CORPORATION, Tokyo (JP)

(72) Inventors: Hiromu ARIGA, Tokyo (JP); Kei WAKABAYASHI, Tokyo (JP); Kazuki MATSUMOTO, Tokyo (JP); Takayuki YAMAMOTO, Tokyo (JP); Amane MUKAI, Tokyo (JP)

(73) Assignee: LY CORPORATION, Tokyo (JP)

(21) Appl. No.: 19/355,299

(22) Filed: Oct. 10, 2025

(30) Foreign Application Priority Data
Oct. 11, 2024 (JP) 2024-179477

(51) Int. Cl. H04N 21/81; H04N 21/488

(52) U.S. Cl. CPC H04N 21/816; H04N 21/4884; H04N 21/8113; H04N 21/812

(57) ABSTRACT

A non-transitory computer readable medium storing a program, which when executed by a server configured to communicate with a terminal, causes the server to implement the information processing method, the method including generating, by a controller of the server, a first itinerary based on first information input to the terminal by a user, generating, by the controller, a first video related to the first itinerary, based on the first itinerary, and transmitting the first video to the terminal, by the controller.

### CROSS-REFERENCE TO RELATED APPLICATIONS

This application claims priority under 35 U.S. C. § 119 to Japanese Patent Application No. 2024-179477, filed on Oct. 11, 2024, in the Japanese Property Office (JPO), the entire contents of which are incorporated herein by reference.

### BACKGROUND

### 1. Technical Field

The present disclosure relates to programs, information processing methods, servers, and the like.

### 2. Description of the Related Art

When a user makes a travel plan and creates an itinerary, the itinerary may be created based on the user's hobbies and preferences. For example, a travel planning system may propose a travel that matches each user's preference.

### SUMMARY

An example embodiment of the present disclosure provide a non-transitory computer readable medium storing a program thereon, which when executed by a server configured to communicate with a terminal, causes the server to implement an information processing method comprising generating, by a controller of the server, a first itinerary based on first information input to the terminal by a user, generating, by the controller, a first video related to the first itinerary, based on the first itinerary. and transmitting the first video to the terminal, by the controller.

An example embodiment of the present disclosure provide an information processing method to be performed by a server configured to communicate with a terminal, the method including generating, by a controller of the server, a first itinerary based on first information input to the terminal by a user, generating, by the controller, a first video related to the first itinerary, based on the first itinerary, and transmitting the first video to the terminal.

An example embodiment of the present disclosure provide a server configured to communicate with a terminal, and comprising a controller configured to: (i) generate a first itinerary based on first information input to the terminal by a user, (ii) generate a first video related to the first itinerary, based on the first itinerary, and (iii) transmit the first video to the terminal.

### BRIEF DESCRIPTION OF THE DRAWINGS

The above and other aspects, features, and advantages of certain example embodiments of the disclosure will be more apparent from the following description taken in conjunction with the accompanying drawings.

FIG. 1 shows a system configuration of a communication system according to a first example embodiment.

FIG. 2 shows a function implemented by a controller of a server according to the first example embodiment.

FIG. 3 shows information stored in a storage of the server according to the first example embodiment.

FIG. 4 shows account registration data according to the first example embodiment.

FIG. 5 shows a function implemented by a controller of a terminal according to the first example embodiment.

FIG. 6 shows information stored in a storage of the terminal according to the first example embodiment.

FIG. 7 shows screens appearing on a display of the terminal according to the first example embodiment.

FIG. 8 shows screens appearing on the display of the terminal according to the first example embodiment.

FIG. 9 shows screens appearing on the display of the terminal according to the first example embodiment.

FIG. 10 shows a screen appearing on the display of the terminal according to the first example embodiment.

FIG. 11 is a flowchart showing a processing flow performed by the devices according to the first example embodiment.

FIG. 12 shows screens appearing on the display of the terminal according to a second example embodiment.

### DETAILED DESCRIPTION

### Compliance With Legal Requirements

It should be noted that the disclosure provided herein is premised on compliance with legal requirements, such as secrecy of communication, in the country in which the present disclosure is to be implemented.

### Example Embodiments

Note that the phrase “for example” is used in some parts of the present specification for ease of understanding, while it should be noted that not only those parts but the entirety of the following example embodiments is not limited to the content described therein.

The following describes some example embodiments for implementing a program and the like according to the present disclosure, with reference to the drawings.

The production of a terminal according to an example embodiment of the present application (a terminal of an example embodiment) may include, for example, a concept that a state in which the functions of the terminal are implementable on the terminal owned (carried) by a user (e.g., a state in which the functions of the terminal are implemented according to the example embodiment of the present application) as a result of or by this terminal receiving (or receiving and storing) a program (e.g., an application program) or the like described herein.

Also, the production of a system according to an example embodiment of the present application (a system of an example embodiment) may include, for example, a concept that a state in which the functions of the system are implemented (e.g., a state in which the system according to the example embodiment of the present application are implementable) as a result of or by a terminal included in the system of the example embodiment receiving a program (e.g., an application program) or the like described herein that is transmitted from a server included in the system according to the example embodiment of the present application (or as a result of the received program being stored in the terminal or by storing the received program in the terminal).

As used herein, the term “system” may include a plurality of devices, for example.

The plurality of devices may be a combination of devices of the same type, a combination of devices of different types, or a combination of devices of the same type and devices of different types.

Note that, for example, the system can also be considered as the plurality of devices cooperating with each other to perform certain processing.

The term “a system related to a client (client device) and a server” may be, for example, considered as at least one of the following cases:
(1) a terminal and a server;
(2) a server; or
(3) a terminal.

In the case (1), the system includes, for example, at least one terminal and at least one server. The system in this example is a client-server system.

The server is constituted by, for example, the following devices, which may be a single device or a combination of a plurality of devices.

For example, the server may have any one or more of the following: a processor (e.g., a central processing unit (CPU), a graphics processing unit (GPU), an accelerated processing unit (APU), a digital signal processor (DSP), an application specific integrated circuit (ASIC), a field programmable gate array (FPGA) etc.), a computer device (e.g., a processor and a memory), a control device, an arithmetic device, and a processing unit. The server may include two or more of any one of the above devices of the same type (e.g., two CPUs, a homogeneous multi-core processor etc.) or include two or more of any one of the above devices of different types (e.g., a CPU and a DSP, a heterogeneous multi-core processor etc.), or may be a combination of two or more devices (e.g., a processor and a computer device, a processor and an arithmetic device, a heterogeneous configuration of two or more devices, etc.).

Note that the processor may be a virtual processor.

When the server constituted by or including a single device performs a certain type of processing, the single device may perform the processing described in the examples. If the server includes or is constituted by a plurality of devices, some of the devices may perform one part of the processing and another device may perform the other part of the processing. For example, if the server includes a processor and an arithmetic device, the processor may perform first processing and the arithmetic device may perform second processing.

If the server includes a plurality of devices, the devices may be disposed at physically separated locations.

Functions of the server may be provided, for example, in the form of Platform as-a-Service (PaaS), Infrastructure as-a-Service (IaaS), or Software as-a-Service (SaaS) in cloud computing.

A controller of the system can be at least either a controller of the terminal or a controller of the server. That is, for example, any of the following can be the controller of the system: (1A) only the controller of the terminal; (1B) only the controller of the server; or (1C) both the controller of the terminal and the controller of the server.

Control and processing (hereinafter collectively referred to as “control and the like”) performed by the controller of the system may be: (1A) performed solely by the controller of the terminal; (1B) performed solely by the controller of the server; or (1C) performed by both the controller of the terminal and the controller of the server.

In the case (1C), for example, part of control and the like performed by the controller in the system may be performed by the controller of the terminal, and the remainder of the control and the like may be performed by the controller of the server. In this case, the allocation of the control and the like may be equal or different from the equal allocation.

If the server includes or is constituted by a single apparatus, the term “a communication device of the server” may refer to a communication device included in the single apparatus. If the server includes a plurality of devices, the communication device of the server may include communication devices included in the respective devices.

For example, if the server includes a first device and a second device, the first device has a first communication device, and the second device has a second communication device, the term “a communication device of the server” may refer to a concept that includes the first communication device and the second communication device.

In the case (2), the system may include, for example, a plurality of servers (hereinafter referred to as a “server system”). In this case, the aforementioned configuration can be similarly applied to each of the servers.

Control and the like performed by the server system may be performed by: (2A) only one of the plurality of servers; (2B) only another one of the servers; or (2C) one server and another server out of the plurality of servers.

In the case (2C), for example, part of control and the like performed by the server system may be performed by one server, and the remainder of the control and the like may be performed by another server. In this case, the allocation of the control and the like may be equal or different from the equal allocation.

In the case (3), the system may include, for example, a plurality of terminals.

This system may be, for example, as follows:
a system in which terminals have server functions (e.g., distributed system), which can be implemented, for example, by using a blockchain technology; or
a system in which terminals wirelessly communicate with each other, which can be implemented, for example, by performing communication in a peer-to-peer (P2P) method using a short-range wireless communication technology, such as Bluetooth®.

Note that the above description is not limited to the controller, but also applies to functional parts such as input/output devices, communication devices, storages, and/or clocks that can be constituent elements of the system.

In the following example embodiments, for example, a system that includes terminals and a server (e.g., a client-server system) will be illustrated.

Note that the server system in the above case (2) can also be applied as the server.

Instead of the system that includes terminals and a server, for example, the system in the above case (3) can be applied as a system that does not include a server.

An example embodiment in this case can be configured based on the aforementioned blockchain technology or the like. For example, data stored and managed in a server described in any of the following example embodiments may be kept (stored) on a blockchain. The terminal generates a transaction to the blockchain, and data kept on the blockchain can be updated upon the transaction being approved on the blockchain.

Note that, even when the term “terminal” is used, this is not limited to the meaning of a terminal as a client device in a client-server system.

That is, the term “terminal” may also include a concept of a device that is not included in a client-server system.

In the present specification, the expression “via a communication I/F” is used as appropriate. This expression means that, for example, a device may transmit and receive various types of information and data via the communication I/F (via a communication device) under the control of a controller (e.g., a processor, etc.).

Regarding the terms “related to” and “associated with” as used herein, “B related to A” and “B associated with A” may mean, for example, that B has a certain relationship with A.A specific example will be described later.

When a device performs processing targeting two or more objects, such as “transmitting A and B” or “receiving A and B” as used herein, the processing may be performed at the same time for A and B (hereinafter expressed as “synchronously”) or at different times for A and B (hereinafter expressed as “asynchronously”).

For example, when first information and second information are transmitted, this may include both concepts of transmitting the first information and the second information at the same time and transmitting the first information and the second information at different times.

Note that, considering a lag (e.g. time lag), “synchronously” may include “substantially synchronously”.

While the term “same” is used in description of example embodiments, it should be understood that some imprecisions may exist. Thus, when one element or timing is referred to as being the same as another element or timing, it should be understood that the one element or timing is the same as another element or timing within a desired tolerance range (e.g., ±10%).

When the terms “about” or “substantially” are used in this specification in connection with a numerical value or a timing, it is intended that the associated numerical value or timing includes a tolerance (e.g., ±10%) around the stated numerical value or timing. Further, regardless of whether numerical values or timing(s) are modified as “about” or “substantially,” it will be understood that these values and timing(s) should be construed as including a manufacturing or operational tolerance (e.g., ±10%) around the stated numerical values or timing(s).

Note that, when processing is performed at different times for A and B, this need only mean that the processing is performed targeting A and B, and the purpose need not necessarily be the same.

For example, when the first information and the second information are transmitted as mentioned above, the first information and the second information need only be transmitted, and this may include a case where the first information and the second information are transmitted for the same purpose, and a case where the first information and the second information are transmitted for different purposes.

In the following examples, a messaging service (hereinafter referred to as a “chat service”) is illustrated as an example of a service used by users to chat. An application for realizing the chat service is referred to as a “chat application”. An application for realizing the messaging service is referred to as a “messaging application”.

For example, the chat application enables users to chat in a chat room.

Note that the messaging service (MS; including an instant messaging service (IMS)) can also be considered as one form of a social networking service (social media platform). Thus, the messaging service and the social networking service may be, but need not necessarily be, distinguished from each other. That is, the social networking service may include the messaging service.

In the following examples, an instant messaging service (IMS), in which simple messages are transmitted and received between a plurality of devices (e.g., terminals) via a server, will be illustrated as an example of a messaging service.

An instant messaging application enables users to talk in a talk room, for example.

A chat room (e.g., a talk room) may be a user interface (UI) or a graphical user interface (GUI) that enables each user to view content transmitted and received between terminals of a plurality of users.

A messaging service enables, for example, a user to exchange messages via a talk room by registering any account as a “friend”.

For example, a “friend” may be considered as the relationship between first and second users of the messaging application when the accounts of the first and second users are unidirectionally or bidirectionally associated.

For example, when the account of the first user and the account of the second user are mutually associated, the first and second users may be called “friends”. Also, for example, when the account of the first user has been associated with the account of the second user, the first and second users may be called “friends” even if the account of the second user has not been associated with the account of the first user.

Talk rooms may include, for example, a one-on-one user talk room (hereinafter referred to as a “one-on-one talk room”), a talk room for a group including a plurality of users (hereinafter referred to as a “group talk room”), a talk room for talking with an official account (OA) operator (e.g., a business operator partnered with the messaging service provider) (hereinafter referred to as an “OA talk room”).

An account of a business operator that is an account on a messaging application and is not a general user may be referred to as an “official account (OA),” and the user of the official account may be referred to as an “official user.” Note that this may also be referred to as an “official account user” or “official account operator”, for example.

Meanwhile, an account of a user that is an account on a messaging application and is not an OA operator is referred to as a “general account”, and a user with a general account is called a “general user”. Note that this may also be referred to as a “general account user”, for example.

That is, accounts on a messaging application may include general accounts and official accounts.

An OA operator may be able to, for example, transmit and receive messages to and from other devices via a server, using a terminal similar to a terminal of a user with a general account.

A message (message information) may include, for example, information for which a transmission source and a transmission destination used in a messaging service are determined, information constituted by or including identification information (a message ID) for identifying the message, and/or message content.

The message content may mean the content of a message excluding the message ID, for example. The message content may include one or more content items.

Information set as identification information for identifying a message is referred to as a “message ID”.

It can also be considered that the message content included in a message with the same message ID is identified by this message ID. Therefore, it can also be considered that the identification information for identifying a message has substantially the same meaning as the identification information for identifying the message content.

Note that, unlike this, individual identification information (message content IDs) may optionally be set for each message content item.

The term “content” may include, for example, text content in the form of text, image content in the form of images (including at least either a still image or a moving image), and/or sound content in the form of sound (including voice).

Note that the term “content” may also include operable content such as a button and/or an icon to be operated by the user, and link content such as a URI (including a URL etc.).

The term “text” may include, for example, at least one of characters of any country, extended characters, machine-dependent characters, numerals, symbols, graphics, and/or signs that are represented by character codes.

Note that the term “text” need not necessarily include at least one of the aforementioned characters, extended characters, machine-dependent characters, numerals, symbols, graphics, and/or signs, and may also include any other type of text.

The term “image” may include, for example, at least one of various types of image information such as an icon, a button, a stamp, an emoji, and/or a banner image.

Note that, unlike the above definitions, it may optionally be defined that “content” is a superordinate concept of a message, or that “content” and “message” have the same meaning.

As one example, when an itinerary for a travel plan is created using an application or the like, methods of outputting the created itinerary in the form of text information, photographic information, and/or map information are available. However, for example, it may be difficult for a user to grasp the atmosphere of a travel destination that the user visits for the first time, from the text information or the like regarding the created itinerary.

Some example embodiments of the present disclosure provide services capable of creating (generating) moving image information based on a created itinerary and presenting the moving image information to a user. Hereinafter, moving image information based on a created itinerary may be referred to as an “itinerary video”.

Here, the term “itinerary” may include, for example, an activity plan in the case of traveling or moving. The term “itinerary” may include, for example, chronological and/or spatial designation elements (which may also be referred to as “itinerary elements”), such as any of the elements below. The term “itinerary” may also be rephrased as a “travel plan”.
Departure point and scheduled departure time
Destination and scheduled arrival time
Transportation and time required or desired
Name and address of accommodation facility
Name and address of sightseeing spot
Order of visiting sightseeing spots and length of stay
Eating place and meal content
Budget and payment method

The following describes an example in which, for example, an itinerary and an itinerary video are generated based on an interaction with a chatbot account in a messaging service. Note that, without limitation to a messaging service, the generation of an itinerary video may be implemented in an AI interactive system, such as ChatGPT.

In the following, a question answering system (which may also be referred to as a “question answering model”) may be used as an example of a method of realizing processing. The question answering system may be, for example, a closed-book question answering system implemented by a language model such as HyperCLOVA, GPT-4, or Llama. Also, the question answering model may be, for example, an open-book question answering system implemented by a combination of a language model and an external knowledge retrieval model such as a dense passage retriever (DPR) or a binary passage retriever (BPR).

The question answering system may be configured to generate an output sentence (response sentence) in cooperation with any external database.

### First Example Embodiment

In the first example, for example, a server creates an itinerary and an itinerary video for a user based on the content of messages transmitted to and received from the user.

The content described in the first example can also be applied in the same manner to any other examples and variations.

In the following example, for example, a service for realizing itinerary creation assistance is referred to as a “travel plan creation assistance service”. The travel plan creation assistance service may become available as a result of the user interacting (or based on the user's interaction) with a chatbot in a messaging application, for example.

Note that, for example, any of the following modes can be applied as a mode for realizing the travel plan creation assistance service:
(A1) a mode in which a messaging application has the function of the travel plan creation assistance service as one of its functions;
(A2) a mode in which a travel plan creation assistance application that provides the travel plan creation assistance service has the function of the messaging service as one of its functions;
(B1) a mode of configuring an application (e.g., integrated application) that has the functions of the messaging service and the travel plan creation assistance service;
(C1) a mode of configuring a travel plan creation assistance application as an application separate from a messaging application;
(C2) a mode of configuring a messaging application as an application separate from a travel plan creation assistance application; and
(D) a mode of configuring a travel plan creation assistance application as a standalone application.

In the modes (A1), (A2), and (B1), for example, the messaging service provider can be the same as the travel plan creation assistance service provider.

In this case, a configuration, in which the user uses the same user account across the messaging application and the travel plan creation assistance application, is possible.

Also, in this case, a configuration is possible, as another method, in which a user account on the messaging application is automatically associated (linked) with a user account on the travel plan creation assistance application.

In the modes (C1) and (C2), for example, the messaging service provider may be different from the travel plan creation assistance service provider.

Also, in the modes (C1) and (C2), it is possible to perform processing for associating (linking) a user account on the messaging application with a user account on the travel plan creation assistance application.

In the following description, for example, the messaging service provider manages and administers a server 10 for providing the messaging service and the travel plan creation assistance service, in accordance with the mode (A1). That is, the following describes an example of generating an itinerary (and an itinerary video) through text communication with a chatbot on the messaging application. However, the travel plan generation method according to the present disclosure is not limited to this example. For example, in the case of the travel plan creation assistance application in the mode (A2) (or another application in the mode (C1) or (C2)), it is possible to generate an itinerary (and an itinerary video) by repeatedly asking the user a plurality of questions regarding places to visit or the like during the travel (which may be, for example, questions to which the user can select “like” or “dislike” by a swiping operation etc. on the application, but are not limited thereto).

In the following description, a user of a terminal 20A that communicates with the server 10 is referred to as a “user A.A”, a user of a terminal 20B as a “user B.B”, a user of a terminal 20C as a “user C.C”, and so on.

### System Configuration

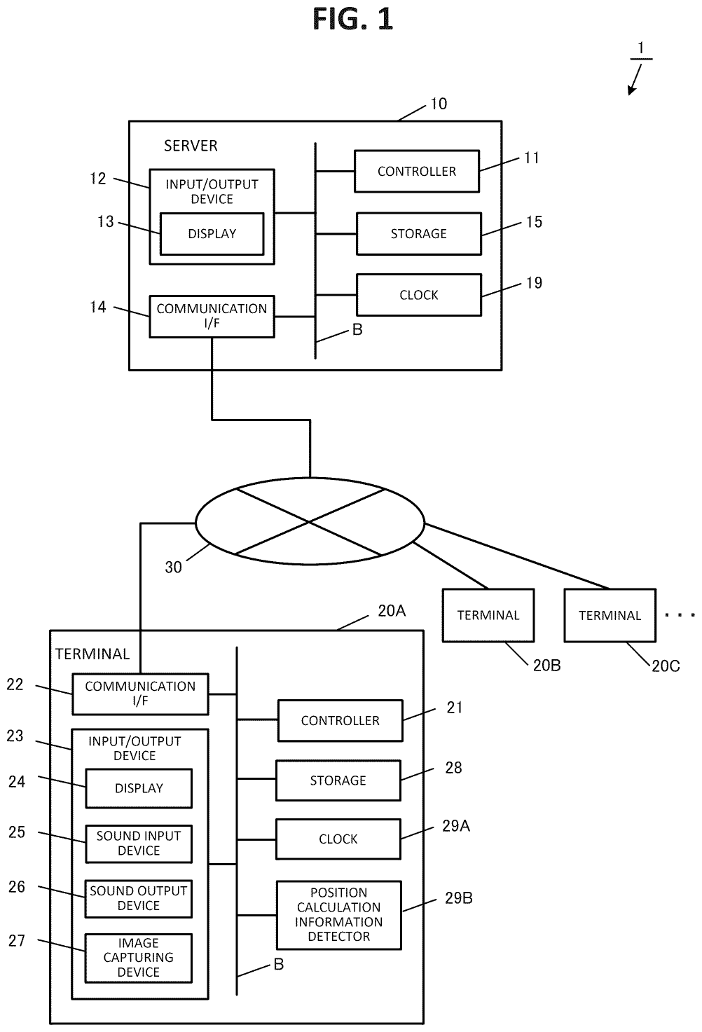

FIG. 1 shows a system configuration of a communication system 1 according to this first example embodiment. In the communication system 1, for example, the server 10 and a plurality of terminals 20 (terminals 20A, 20B, 20C, . . . ) are connected to each other via a network 30.

The server 10 functions to provide, for example, a messaging service and a travel plan creation assistance service to the terminals 20 owned by the users, via the network 30.

The server 10 can also be referred to as, for example, a messaging service server, a travel plan creation assistance server, and/or a social media platform server. In this example, for example, the user of the server 10 is a company that provides the messaging service and the travel plan creation assistance service (a provider of the messaging service and the travel plan creation assistance service). Note that the number of servers 10 and terminals 20 that are connected to the network 30 is not limited to the above.

In this example, the “travel plan creation assistance service” is a service provided by the provider (server 10) that is a company or the like providing the travel plan creation assistance service, and may be provided to, for example, the users (the terminals 20 of the users).

Each of the terminals 20 (terminals 20A, 20B, 20C, . . . ) may be any type of information processing terminal that is capable of realizing the functions described in the examples. Examples of the terminals 20 include a smartphone, a mobile phone (a feature phone), a computer (e.g., a desktop, a laptop, or a tablet), a media computer platform (e.g., a cable, a satellite set-top box, or a digital video recorder), a handheld computer device (e.g., a personal digital assistant (PDA) or an electronic mail client), a wearable terminal (an eyeglasses-type device, a watch-type device, etc.), a virtual reality (VR) terminal, a smart speaker (an audio recognition device), and any other type of computer or communication platform. The terminals 20 may also be referred to as “information processing terminals”.

The terminals 20A, 20B, and 20C may have, for example, the same configuration. A terminal used by a user X may optionally be referred to as a “terminal 20X”, and user information associated with the user X or the terminal 20X in a desired (or alternatively, predetermined) service may optionally be referred to as “user information X”, as desired.

The user information is information on a user associated with an account used by the user in the desired (or alternatively, predetermined) service. User information includes, for example, information that is input by the user or is assigned by the desired (or alternatively, predetermined) service, and that is associated with the user, such as the name, icon image, age, sex, address, hobbies and preferences, and/or identifier of the user. User information may optionally be any one of these types of information or a combination of two or more of these types of information.

The network 30 serves to connect the devices constituting the communication system 1. That is, the network 30 means a communication network that provides a connection path to enable various types of devices mentioned above to transmit and receive data after the devices are connected to each other.

One or more portions of the network 30 may optionally be a wired network or a wireless network. Examples of the network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of a public switched telephone network (PSTN), a mobile phone network, an integrated service digital network (ISDN), a radio LAN, long term evolution (LTE), code division multiple access (CDMA), Bluetooth (registered trademark), satellite communication, and a combination of two or more of these networks. The network 30 may include one or more networks 30.

The server 10 (a non-limiting example of a server, an information processing device, or an information management device) functions to provide a desired (or alternatively, predetermined) service (a messaging service and travel plan creation assistance service in this example) to the terminals 20 and the like. The server 10 may be any information processing device that is capable of realizing the functions described in the example embodiments. Examples of the server 10 include a server device, a computer (e.g., a desktop, a laptop, or a tablet), a media computer platform (e.g., a cable, a satellite set-top box, or a digital video recorder), a handheld computer device (e.g., a PDA or an electronic mail client), and any other type of computer or communication platform. The server 10 may also be referred to as an “information processing device”. If the server 10 and the terminals 20 need not be distinguished from each other, each of the server 10 and the terminals 20 may optionally be referred to as an “information processing device”.

### Hardware (HW) Configurations of Devices

HW configurations of the devices included in the communication system 1 will be described.

### (1) HW Configuration of Terminal

FIG. 1 shows an example of a HW configuration of the terminal 20.

The terminal 20 includes, for example, a controller 21 (central processing unit: CPU), a storage 28, a communication I/F (interface) 22, an input/output device 23, a clock 29A, and a position calculation information detector 29B. The HW constituent elements of the terminal 20 are connected to each other via a bus B, for example. Note that it is not essential to include all of the constituent elements as the HW configuration of the terminal 20. For example, the terminal 20 may optionally be configured such that each one or a plurality of constituent elements are removable.

The communication I/F 22 transmits and receives various data via the network 30. Communication may be performed in a wired or wireless manner, and may be based on any communication protocol that enables mutual communication to be performed. The communication I/F 22 functions to communicate with various devices such as the server 10, via the network 30. The communication I/F 22 transmits various data to various devices, such as the server 10, in accordance with instructions from the controller 21. Also, the communication I/F 22 receives various data transmitted from various devices, such as the server 10, and transfers the data to the controller 21. The communication I/F 22 may also be simply referred to as a “communication device”. The communication I/F 22 may also be referred to as a “communication circuit” in the case where the communication I/F is constituted by or includes a physically structured circuit.

The input/output device 23 includes, for example, a device that inputs various operations made to the terminal 20, and a device that outputs the results of processing performed by the terminal 20. The input/output device 23 may optionally be constituted by or may optionally include a single, integrated input and output device, or separate input and output devices.

The input device is implemented by any one of all types of devices capable of receiving input from a user and transferring information regarding the input to the controller 21, or a combination of two or more of these types of devices. Examples of the input device include a touch panel, a touch display, hardware keys of a keyboard or the like, a pointing device such as a mouse, a camera (operation input via moving images), and a microphone (operation input using voice).

The output device is implemented by any one of all types of devices capable of outputting the result of processing performed by the controller 21, or a combination of two or more of these types of devices. Examples of the output device include a touch panel, a touch display, a speaker (sound output), a lens (e.g., three-dimensional (3D) output or hologram output), and a printer.

As an example, the input/output device 23 includes, for example, a display 24, a sound input device 25, a sound output device 26, and an image capturing device 27.

The display 24 is implemented by any one of all types of devices capable of providing display in accordance with display data written in a frame buffer, or a combination of two or more of these types of devices. Examples of the display 24 include a touch panel, a touch display, a monitor (e.g., a liquid crystal display and an organic electroluminescence display (OELD)), a head mounted display (HDM), and devices capable of displaying images, text information, and the like using projection mapping or holograms, or in the air (may optionally be a vacuum). Note that the display 24 may optionally be capable of displaying display data three-dimensionally.

The sound input device 25 is used to input sound data (which may include audio data; the same applies hereinafter). The sound input device 25 includes a microphone or the like.

The sound output device 26 is used to output sound data. The sound output device 26 includes a speaker or the like.

The image capturing device 27 is used to acquire image data (which may include still image data and moving image data; the same applies hereinafter). The image capturing device 27 includes a camera or the like.

When the input/output device 23 is a touch panel, the input/output device 23 and the display 24 may have substantially the same size and shape and be arranged facing each other.

The clock 29A is a built-in clock of the terminal 20 and outputs time information (time measurement information). The clock 29A includes, for example, a clock that utilizes a crystal oscillator or the like. The clock 29A may also be referred to as, for example, a “time measurement device” or a “time information detector”.

Note that the clock 29A may optionally include a clock to which NITZ (Network Identity and Time Zone) standards or the like are applied.

The position calculation information detector 29B is a functional part that detects (measures) information (hereinafter referred to as “position calculation information”) that is necessary or desired for the controller 21 to calculate (measure) the position of the terminal 20. The position calculation information detector 29B may also be referred to as a “position calculation sensor device”, for example.

Examples of the position calculation information detector 29B include a satellite positioning sensor (a satellite positioning unit) that is a sensor or a unit for calculating the position of the terminal 20 using a satellite positioning system, such as a global positioning system (GPS), an inertial measurement sensor (inertial measurement unit (IMU)) that is a sensor or a unit for calculating the position of the terminal 20 using an inertial navigation system, and/or a ultra-wide band (UWB) positioning sensor (UWB positioning unit) that is a sensor or a unit for calculating the position of the terminal 20 using a UWB.

The satellite positioning unit has, for example, an radio frequency (RF) receiving circuit that converts, into digital signals, RF signals, which include positioning satellite signals emitted from a positioning satellite and received by an antenna (not shown), and a baseband processing circuit that captures the positioning satellite signals by performing correlation operation processing or the like on the digital signals output from the RF receiving circuit and outputs, as position calculation information, information such as satellite orbit data and time data that are retrieved from the positioning satellite signals.

The inertial measurement unit includes an inertial sensor that detects information necessary or desired to calculate the position of the terminal 20 through an inertial navigation operation. The inertial sensor includes, for example, a three-axis acceleration sensor and a three-axis gyroscope sensor, and outputs, as position calculation information, an acceleration detected by the acceleration sensor and an angular velocity detected by the gyroscope sensor.

The UWB positioning unit has, for example, a ultra-wide band radio frequency (RF) receiving circuit that converts, into digital signals, ultra-wide band RF signals including a positioning ultra-wide band pulse signal emitted from a positioning beacon and received by an antenna (not shown), and a relative position calculation processing circuit that calculates the relative positions of the terminal 20 and the positioning beacon based on the digital signals output from the ultra-wide band RF receiving circuit.

Note that, for example, the UWB positioning unit may optionally cause the terminal 20 to function as a positioning beacon by transmitting ultra-wide band RF signals including a positioning ultra-wide band pulse signal from the antenna (not shown).

For example, the controller 21 calculates the position of the terminal 20 at periodical or specified times, based on the position calculation information detected by the position calculation information detector 29B. The position of the terminal will be referred to as a “terminal position”, and the calculated terminal position will be referred to as a “calculated terminal position”. The controller 21 may optionally store, in the storage 28, the calculated terminal position as calculated terminal position history data in association with the date and time at which the calculated terminal position was calculated.

The controller 21 has a physically structured circuit for executing functions that are implemented by code or commands included in a program, and is implemented by, for example, a data processing device incorporated in hardware. Thus, the controller 21 may optionally be referred to as a “control circuit”.

Examples of the controller 21 include a central processing unit (CPU), a microprocessor, a processor core, a multiprocessor, an application-specific integrated circuit (ASIC), and a field programmable gate array (FPGA).

The storage 28 functions to store various programs and data that are necessary or desired for the terminal 20 to operate. Examples of the storage 28 include various storage media, such as a hard disk drive (HDD), a solid state drive (SSD), a flash memory, a random access memory (RAM), and a read only memory (ROM). The storage 28 may optionally be referred to as a “memory”.

The terminal 20 stores a program P in the storage 28, and the controller 21 executes the program P to perform processing to serve as parts that are included in the controller 21. That is, the program P stored in the storage 28 causes the terminal 20 to implement the functions executed by the controller 21.

The program P may optionally be referred to as a “program module”.

### (2) HW Configuration of Server

FIG. 1 shows an example of a HW configuration of the server 10.

The server 10 includes, for example, a controller (CPU) 11, a storage 15, a communication I/F (interface) 14, an input/output device 12, a display 13, and a clock 19. The HW constituent elements of the server 10 are connected to each other via a bus B, for example. Note that it is not essential to include all of the constituent elements as the HW configuration of the server 10. For example, the HW of the server 10 may optionally be configured such that each one or a plurality of constituent elements are removable.

The controller 11 has a physically structured circuit for executing functions that are implemented by code or commands included in a program, and is implemented by, for example, a data processing device incorporated in hardware.

The controller 11 is typically a central processing unit (CPU), and may optionally be a microprocessor, a processor core, a multiprocessor, an ASIC, or an FPGA. In the present disclosure, the controller 11 is not limited to these examples.

The storage 15 functions to store various programs and data that are necessary or desired for the server 10 to operate. The storage 15 is implemented by various storage media, such as an HDD, an SSD, and a flash memory. However, in the present disclosure, the storage 15 is not limited to these examples. The storage 15 may optionally be referred to as a “memory”.

The communication I/F 14 transmits and receives various data via the network 30. Communication may be performed in a wired or wireless manner, and may be based on any communication protocol that enables mutual communication to be performed. The communication I/F 14 functions to communicate with various devices, such as the terminal 20, via the network 30. The communication I/F 14 transmits various data to various devices, such as the terminal 20, in accordance with instructions from the controller 11. Also, the communication I/F 14 receives various data transmitted from the various devices, such as the terminal 20, and transfers the data to the controller 11. The communication I/F 14 may also be referred to simply as a “communication device”. The communication I/F 14 may also be referred to as a “communication circuit” in the case where the communication I/F is constituted by or includes a physically structured circuit.

The input/output device 12 includes, for example, a device that inputs various operations to the server 10, and a device that outputs the results of processing performed by the server 10. The input/output device 12 may optionally be constituted by or may include a single, integrated input and output device, or separate input and output devices.

The input device is implemented by any one of all types of devices capable of receiving input from a user and transferring information regarding the input to the controller 11, or a combination of two or more of these types of devices. The input device is implemented by hardware keys, a typical example of which is a keyboard, and a pointing device such as a mouse. Note that, for example, the input device may optionally include a touch panel, a camera (operation input made via moving images), or a microphone (operation input using voice).

The output device is implemented by any one of all types of devices capable of outputting the result of processing performed by the controller 11, or a combination of two or more of these types of devices. Examples of the output device include a touch panel, a touch display, a speaker (sound output), a lens (e.g., 3D (three-dimensional) output and hologram output), and a printer.

As one example, the input/output device 12 includes, for example, a display 13.

The display 13 is implemented by a display or the like. The display is typically implemented by a monitor (e.g., a liquid crystal display or an organic electroluminescence display (OELD)). Note that the display may optionally be a head mounted display (HDM) or the like. Note that the display may optionally be capable of displaying display data three-dimensionally. In the present disclosure, the display is not limited to these examples.

The clock 19 is a built-in clock of the server 10 and outputs time information (time measurement information). The clock 19 includes, for example, a real time clock (RTC) as a hardware clock, a system clock, or the like. The clock 19 may also be referred to as, for example, a “time measurement device” or a “time information detector”.

### (3) Others

The server 10 stores the program P in the storage 15, and the controller 11 executes the program P to perform processing to serve as parts that are included in the controller 11. That is, the program P stored in the storage 15 causes the server 10 to implement the functions executed by the controller 11. The program P may optionally be referred to as a “program module”.

The same applies to the other devices.

Some example embodiments of the present disclosure will be described as being implemented as a result of (or based on) a CPU of the terminal 20 and/or the server 10 executing the program P.

The same applies to the other devices.

Note that the controller 21 of the terminal 20 and/or the controller 11 of the server 10 may optionally implement processing by using not only a CPU including a control circuit, but also a logic circuit (hardware) or a dedicated circuit formed on an integrated circuit (IC) chip or a large scale integration (LSI) chip. Further, these circuits may optionally be implemented by one or more integrated circuits, and a plurality of types of processing described in some example embodiments may optionally be implemented by a single integrated circuit. An LSI may also be referred to as a VLSI, a super LSI, an ultra LSI, or the like depending on the chip integration density. Accordingly, the controller 21 may optionally be referred to as a “control circuit”.

The same applies to the other devices.

The program P (e.g., a software program, a computer program, or a program module) in some example embodiments of the present disclosure may optionally be provided in a state of being stored in a computer-readable storage medium. The program P can be stored in a “non-transitory tangible medium”. Also, the program P may optionally be for implementing some of the functions described in some example embodiments of the present disclosure. Furthermore, the program P may optionally be a differential file (differential program) that enables the functions described in some example embodiments of the present disclosure to be implemented in combination with the program P that is already recorded in a storage medium.

The storage medium may include one or more semiconductor-based or other integrated circuits (ICs; e.g., field programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards or drives, any other suitable storage media, or a suitable combination of two or more of these storage media. Where appropriate, the storage medium may consist only of a volatile storage medium or a non-volatile storage medium, or a combination of volatile and non-volatile storage media. Note that the storage medium is not limited to these examples, and may be any device or medium that is capable of storing the program P. Further, the storage medium may optionally be referred to as a “memory”.

The server 10 and/or the terminal 20 can implement functions of a plurality of functional parts described in some example embodiments by reading the program P stored in the storage medium and executing the read program P.

The same applies to the other devices.

The program P according to some example embodiments of the present disclosure may optionally be provided to the server 10 and/or the terminals 20 via any transmission medium (a communication network, broadcast waves, etc.) that is capable of transmitting the program. The server 10 and/or the terminals 20 implement(s), for example, the functions of the functional parts described in some example embodiments by executing the program P downloaded via the Internet or the like.

The same applies to the other devices.

Some example embodiments of the present disclosure may also be implemented in the form of a data signal in which the program P is embodied by electronic transmission.

At least a portion of processing performed in the server 10 and/or the terminal 20 may optionally be implemented through cloud computing constituted by or including one or more computers.

At least a portion or all of processing to be performed in the terminals 20 may optionally be performed by the server 10. In this case, the server 10 may optionally perform processing to be performed by some or all of the functional parts of the controller 21 of the terminal 20.

At least a portion or all of processing to be performed in the server 10 may optionally be performed by the terminals 20. In this case, the terminal 20 may optionally perform processing to be performed by some or all of the functional parts of the controller 11 of the server 10.

In some example embodiments of the present disclosure, configurations for determination are not essential unless explicitly mentioned otherwise. Desired (or alternatively, predetermined) processing may optionally be activated when a determination condition is satisfied or when a determination condition is not satisfied.

The program according to some example embodiments of the present disclosure is implemented using, for example, a script language such as ActionScript or JavaScript (registered trademark), a compiler language such as Objective-C or Java (registered trademark), or a markup language such as HTML Living Standard.

### Functional Configuration of Each Device

### (1) Functional Configuration of Server

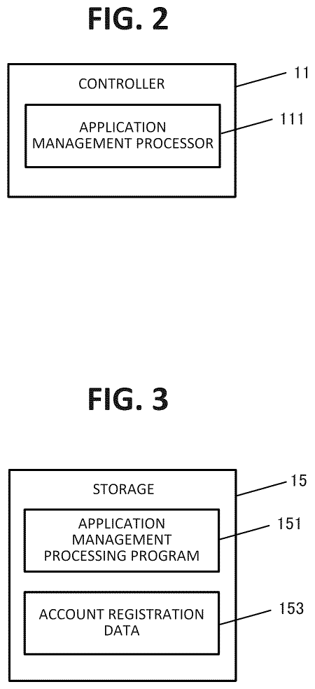

FIG. 2 shows an example of a function implemented by the controller 11 of the server 10 in this example.

The controller 11 includes, for example, an application management processor 111 as a functional part.

The application management processor 111 functions, for example, to perform application management processing in accordance with an application management processing program 151 stored in the storage 15.

FIG. 3 shows an example of information stored in the storage 15 of the server 10 in this example.

The storage 15 stores, for example, the application management processing program 151 that is executed as application management processing, and account registration data 153.

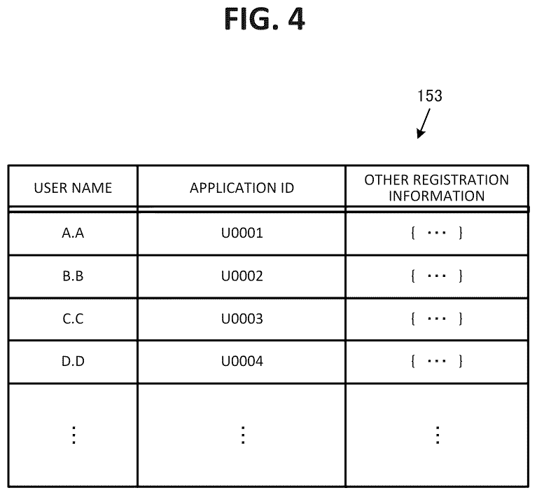

The account registration data 153 is registered data related to accounts on an application (a messaging application in this example), and an example of a data configuration thereof is shown in FIG. 4.

The account registration data 153 includes, for example, a username, an application ID, and other registered information, which are stored in association with each other.

The username refers to a name of an account of the terminal 20 that uses this application. For example, a name registered by the user of the terminal 20 when using the application is stored as the username.

The application ID is information that is used to identify an account of the application, or the account itself.

For example, the application ID may be a value unique to each account. For example, a value (specific value) unique to each account is set and stored as the application ID by the server 10.

The application ID is information associated with the terminal 20 or the user of the terminal 20, and is an example of information regarding the terminal or information regarding the user of the terminal.

Other registration information may include, for example, various types of information such as identification information for identifying the terminal 20, a telephone number (terminal telephone number) of the terminal 20, an email address (terminal email address), and authentication information such as a password (login password, authentication password etc.) used in various authentications on the application.

Identification information for identifying the terminal 20 may be, for example, a terminal ID (e.g., an IMEI (International Mobile Equipment Identity)).

For example, other registration information may be stored in association with user information.

Note that the term “application ID” may alternatively be, but need not necessarily be, referred to as the term “user ID”. If the application allows registration of only one account per terminal 20, for example, identification information for identifying the terminal 20 may be equivalent to identification information for identifying the user of the terminal 20, and may also be equivalent to the application ID.

For example, a plurality of terminal IDs may optionally be allocated to one application ID. In this case, the application may optionally be started on a plurality of terminals 20 at the same time for one application ID as an identification (login) target.

Instead of using various IDs such as the application ID, a technique of managing each account using information such as a terminal telephone number can also be applied.

In this case, instead of storing ID information such as the application ID as the account registration data 153, information such as the terminal telephone number can be stored as the account registration data 153. Note that, instead of replacing the ID information such as the application ID with the information such as the terminal telephone number, the ID information such as the application ID may optionally be stored in one-to-one correspondence with the information such as the terminal telephone number.

In the description of the following examples, it is assumed that one account is registered per terminal 20 for simplicity of explanation.

In this case, since the identification information for identifying the terminal 20 is equivalent to the identification information for identifying the user of the terminal 20 and to the application ID as mentioned above, the term “a user of an account” used in the following description may optionally be considered to be substantially synonymous with “a terminal of an account”.

### (2) Functional Configuration of Terminal

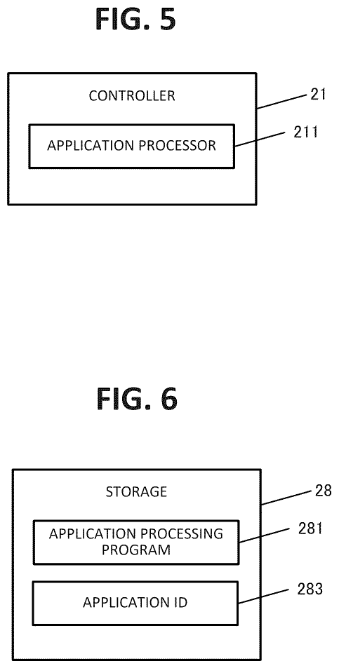

FIG. 5 shows an example of functions implemented by the controller 21 of the terminal 20 in this example.

For example, the controller 21 includes, as a functional part, an application processor 211 for performing application processing in accordance with an application processing program 281 stored in the storage 28.

FIG. 6 shows an example of data or the like stored in the storage 28 of the terminal 20 in this example.

The storage 28 stores, for example, the application processing program 281 that is executed as application processing, and an application ID 283 that corresponds to the terminal 20 or the account of the user of the terminal 20.

### Display Screen

The following describes examples of display screens. Transitions of display screens described below are merely examples of transitions of display screens for realizing the method according to some example embodiments of\ the present disclosure. Regarding the following examples of transitions of display screens, the display of some display screens may be omitted, or another display screen may be added.

Also, the terms used in the display screens described below and the terms used in the processing described later may be different (some terms may not be unified).

The following describes an example in which the terminal 20 is a smartphone having the display 24 that is a vertical display. For example, the smartphone has a touch panel, which functions as an input device and is arranged facing the display to constitute a touchscreen. When an element such as an icon, a button, an item, or an input field is displayed in the display, and the user performs an operation on an area of the touch panel facing the area where the element is displayed, a program associated with the element or a subroutine of the program may be executed.

Note that, in some cases, the flow of a screen transition is illustrated by showing desired (or alternatively, predetermined) screens displayed on different terminals 20 within one drawing or across two or more drawings. In such cases, for example, the different terminals 20 each may be configured to display a desired (or alternatively, predetermined) screen based on at least one of the following events (e.g., in response to at least one of the following events as a trigger):
the desired (or alternatively, predetermined) screen is automatically displayed;
a certain notification (including a push notification, etc.; the same applies to the following) is given to the terminal 20, and the desired (or alternatively, predetermined) screen is displayed in response to the user performing an operation on the notification;
no notification is given to the terminal 20, and the desired (or alternatively, predetermined) screen is displayed in response to the user performing a desired (or alternatively, predetermined) operation on the application; or
a certain notification is given to the terminal 20, and the desired (or alternatively, predetermined) screen is displayed in response to the user performing a desired (or alternatively, predetermined) operation on the application to which the notification has been given.

The following illustrates a case in which an account of the terminal 20A of the user A.A is an example of an account that creates a travel plan.

In this example, a travel plan is created on the messaging application, and “Messaging App” is represented as an example of the name of the messaging application.

Note that the creation of a travel plan may be enabled by an application different from the messaging application (e.g., a travel plan creation assistance application). In this case as well, a similar screen configuration may be used.

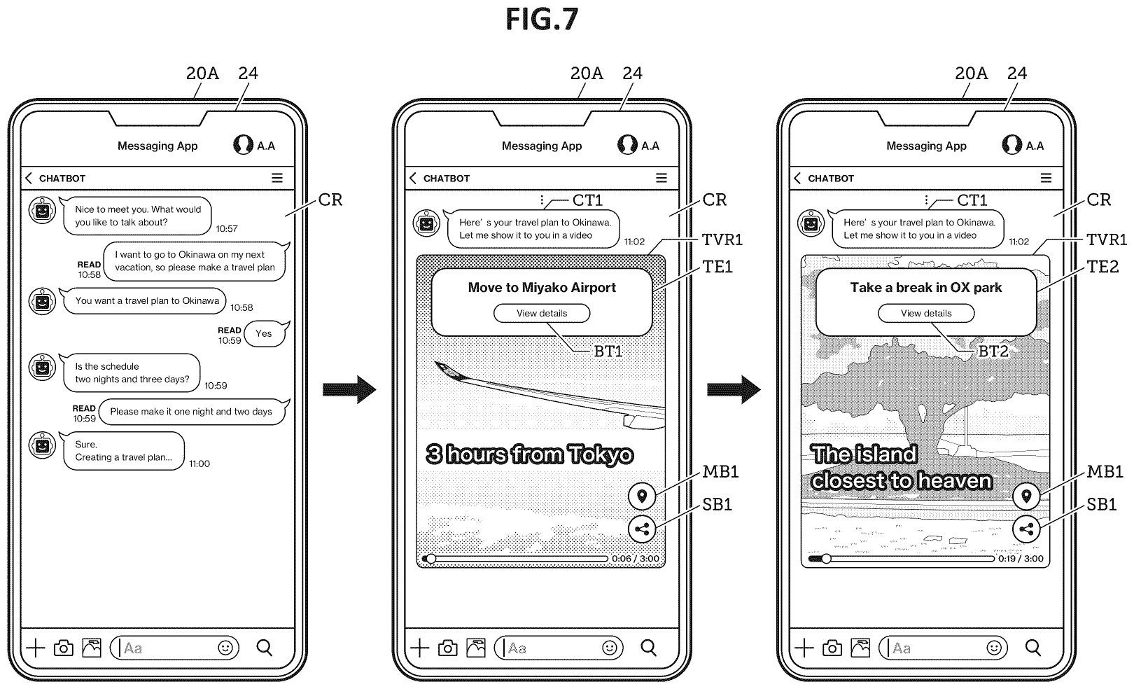

FIGS. 7 to 10 show examples of screens displayed on the display 24 of the terminal 20A in this example.

Note that the term “travel plan”, as used in the drawings, is rephrased as an “itinerary” in the following description, as appropriate.

A left diagram in FIG. 7 shows an example of a talk room screen displayed on the terminal 20A, in which a screen of a one-on-one talk room with a chatbot as a talk partner (chat partner) is displayed. Note that, although the term “chatbot” is used here, it is not specifically limited. For example, an account expressed as an AI chatbot or an AI agent may also be used.

This screen may be displayed when the user selects the chatbot on the messaging application in the same manner as the user sending a message to a friend on the messaging application. In some example embodiments, the screen may be displayed by tapping a function button for starting the travel plan creation assistance service from a main menu or a selection menu in a message room on the messaging application.

On the talk room screen, an area in which content and information similar thereto are displayed (hereinafter referred to as a “content display area CR”) is configured. For example, content transmitted by the user themself (e.g., content whose transmission source is the user) may be displayed on the right side of the screen, and content transmitted by the talk partner (e.g., content whose transmission source is the talk partner) may be displayed on the left side of the screen.

The content may be displayed in association with information that enables specification or identification of the transmission source, and may be, for example, displayed in association with the registered icon image of the user. Further, the content may be displayed in a balloon. In this case, the text or the like in the balloon may be regarded as content, or the balloon itself may also be regarded as being included in the content.

Also, the content may be displayed without a balloon, depending on the type of content and information included in the content.

Different elements (e.g., text, images, and/or objects such as buttons and icons) may be included in one content item. Such a content item may be referred to as “composite content”, for example.

This screen displays an ongoing conversation about travel between the user A.A and the chatbot, and shows a scene in which the user A.A is considering traveling to Okinawa. In this conversation, the user A.A requests the chatbot to change a three-day, two-night itinerary of travel to Okinawa proposed by the chatbot to a two-day, one-night itinerary, and the chatbot acknowledges the request and is in the process of creating the itinerary.

A center diagram in FIG. 7 shows a continuation of the conversation on the left talk room screen, and displays a content item CT1 indicating that an itinerary created (generated) by the chatbot is introduced in a video, and displays, below the content item CT1, an itinerary video information display area TVR1 as an area for displaying the content transmitted by the chatbot.

In the itinerary video information display area TVR1, an itinerary video created by itinerary video creation processing, which will be described later, is displayed and played back. For example, a seek bar indicating a video playback position is displayed on the lower side of the itinerary video information display area TVR1. In addition, for example, a share button SB1 for sharing, with other users, the itinerary video being played back and the itinerary that is the basis of the itinerary video, and a map display button MB1 for checking the itinerary on an electronic map are displayed on the lower right side of the itinerary video information display area TVR1.

A video scene title display area TE1, which indicates which itinerary element of the itinerary the scene of the video that is currently being played back corresponds to, is displayed on the upper side of the itinerary video information display area TVR1. A detailed information display button BT1, which enables the user to check detailed information on an itinerary element, such as a location of a sightseeing spot or the like (e.g., a place of visit) included in the created itinerary information, is displayed on the lower side of the video scene title display area TE1. The detailed information may be regarded as content, and may be configured as composite content, for example. Further, the detailed information may be the itinerary information.

Note that, according to FIG. 7, the video scene title display area TE1 is displayed at a position overlapping the video, but the display position is not limited thereto. For example, the video scene title display area TE1 may alternatively be displayed in an area above or below the video without overlapping the video, or near the seek bar. Further, the display position of the area TE1 may change in accordance with the content of the video (e.g., the display position may change to a position at which the area TE1 does not overlap a major landmark in the video). In some example embodiments, the display position of the area TE1 may change in conjunction with a mark indicating the playback position of the seek bar.

This screen displays, for example, a scene of moving by airplane as a scene of the video. Also, “3 hours from Tokyo”, which is scene text (described later), is displayed in an overlaid manner in accordance with the scene by the controller 21 of the terminal 20A. Note that the scene text may be embedded as image information in a scene of the video.

The characters “Move to Miyako Airport”, which indicate an itinerary element, are displayed in the video scene title display area TE1. For example, tapping the detailed information display button BT1 may cause the screen to transition to a flight display page with a date and time that match the itinerary. In some example embodiments, the screen may be able to transition from the flight display page to a flight reservation page of a relevant airline company.

A right diagram in FIG. 7 shows a continuation (next scene) of the itinerary video in the itinerary video information display area TVR1 on the talk room screen shown in the center in FIG. 7. It can be understood on this screen that, for example, an itinerary element “Take a break in OX park” is incorporated in the itinerary after moving to Miyako Airport. For example, a guide for OX park may be displayed by tapping the detailed information display button BT1.

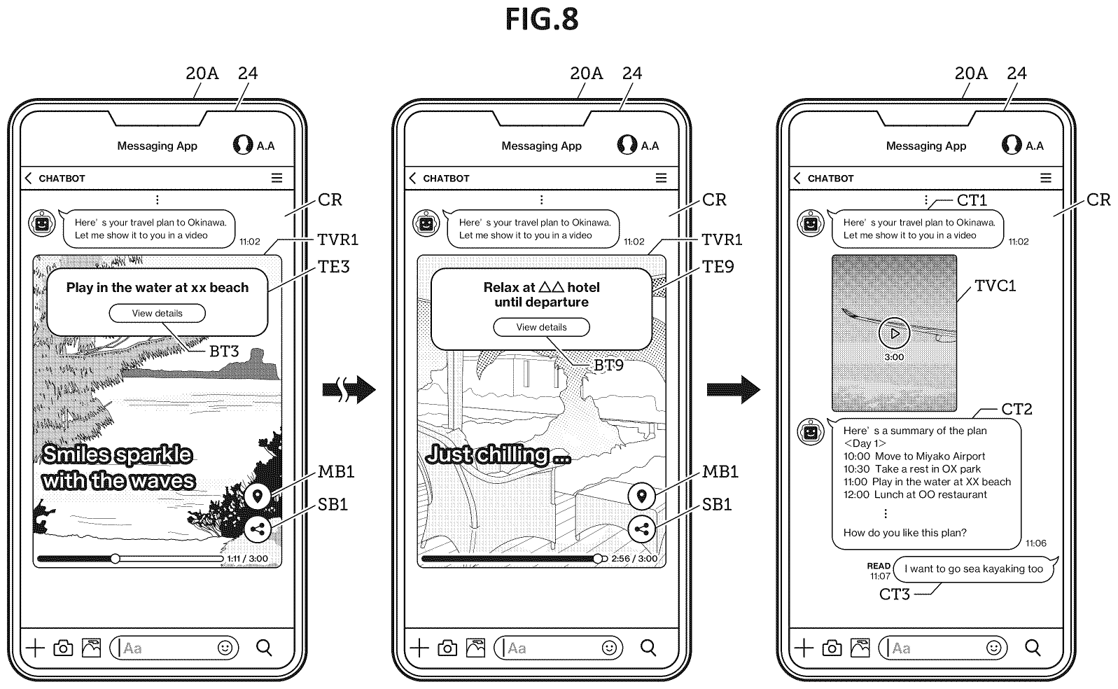

A left diagram in FIG. 8 shows a continuation (next scene) of the itinerary video in the itinerary video information display area TVR1 on the talk room screen in the right diagram of FIG. 7. It can be understood on this screen that, for example, an itinerary element “Play in the water at XX beach” is incorporated in the itinerary after spending time in OX Park. For example, a guide for XX beach may be displayed by tapping a detailed information display button BT3.

A center diagram in FIG. 8 shows the last scene of the itinerary video in the itinerary video information display area TVR1. It can be understood on this screen that, for example, an itinerary element “Relax at ΔΔ hotel until departure” is incorporated as the last item of the itinerary. For example, a guide or a reservation page for ΔΔ hotel may be displayed by tapping a detailed information display button BT9.

A right diagram in FIG. 8 shows a continuation of the talk room screen that is displayed when the playback of the itinerary video ends in the itinerary video information display area TVR1. This screen displays, for example, an itinerary video content item TVC1, which is obtained by reducing the itinerary video information display area TVR1 (e.g., rendering the area TVR1 into a thumbnail), below the aforementioned content item CT1. For example, the itinerary video information display area TVR1 may be expanded again to play back the itinerary video by tapping the itinerary video content item TVC1.

Itinerary information CT2, which is an example of information based on the created itinerary, is displayed below the itinerary video content item TVC1. The itinerary information may be regarded as content, and may be configured as composite content, for example. In this example, the itinerary information is displayed in text format.

Below the itinerary information, a content item CT3 is displayed in which the user A.A says that there is a sightseeing spot (“sea kayaking” in this example) he or she wants to add to the sightseeing spots included in the above itinerary.

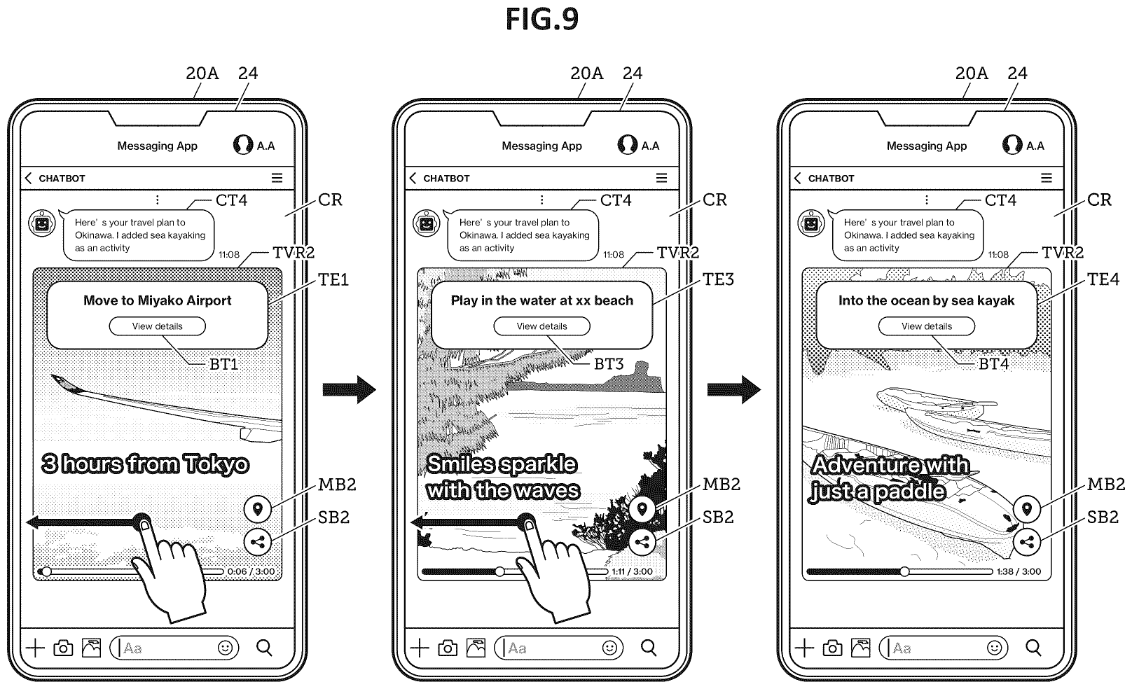

A left diagram in FIG. 9 shows a continuation of the conversation on the talk room screen in the right diagram of FIG. 8, and an itinerary video information display area TVR2 is displayed below a content item CT4 indicating that the chatbot introduces the itinerary re-created based on the content item CT3 in the video. In some example embodiments, when the user swipes the itinerary video information display area TVR2 to the left, a chapter movement operation may be enabled to skip the scene of the itinerary video to the next scene without waiting for the playback of the itinerary video.

A center diagram in FIG. 9 displays the next scene of the itinerary video in the itinerary video information display area TVR2 on the talk room screen in the left diagram of FIG. 9. It can be understood on this screen that, for example, an itinerary element “Play in the water at XX beach” is incorporated in the itinerary after moving to “Miyako Airport”. That is, it can be understood that the itinerary element of “OX Park” is omitted.

When the user swipes to the left, a chapter change operation is performed, and a talk room screen in the right diagram of FIG. 9 is then displayed.

Note that, for example, the display may return to the previous scene when the user swipes to the right in the itinerary video information display area TVR2. The chapter operation is similarly effective in the itinerary video information display area TVR1.

The left diagram in FIG. 8 shows a continuation (next scene) of the itinerary video in the itinerary video information display area TVR1 on the talk room screen in the right diagram of FIG. 7. It can be understood on this screen that, for example, an activity of “sea kayaking” is incorporated in the itinerary as an itinerary element after “Play in the water at XX beach”. For example, a guide page or a tour reservation screen for sea kayaking may be displayed by tapping a detailed information display button BT4.

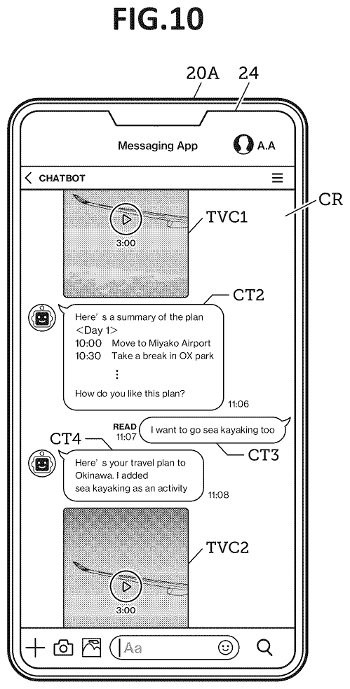

FIG. 10 shows an example of a talk room screen when the playback of the itinerary video ends in the itinerary video information display area TVR2. This screen displays an itinerary video content item TVC2, which is obtained by reducing the itinerary video information display area TVR2, under a content item CT4. For example, the user can easily check again the itineraries before and after modification and select an itinerary by tapping the itinerary video content item TVC1 and the itinerary video content item TVC2.

### Processing

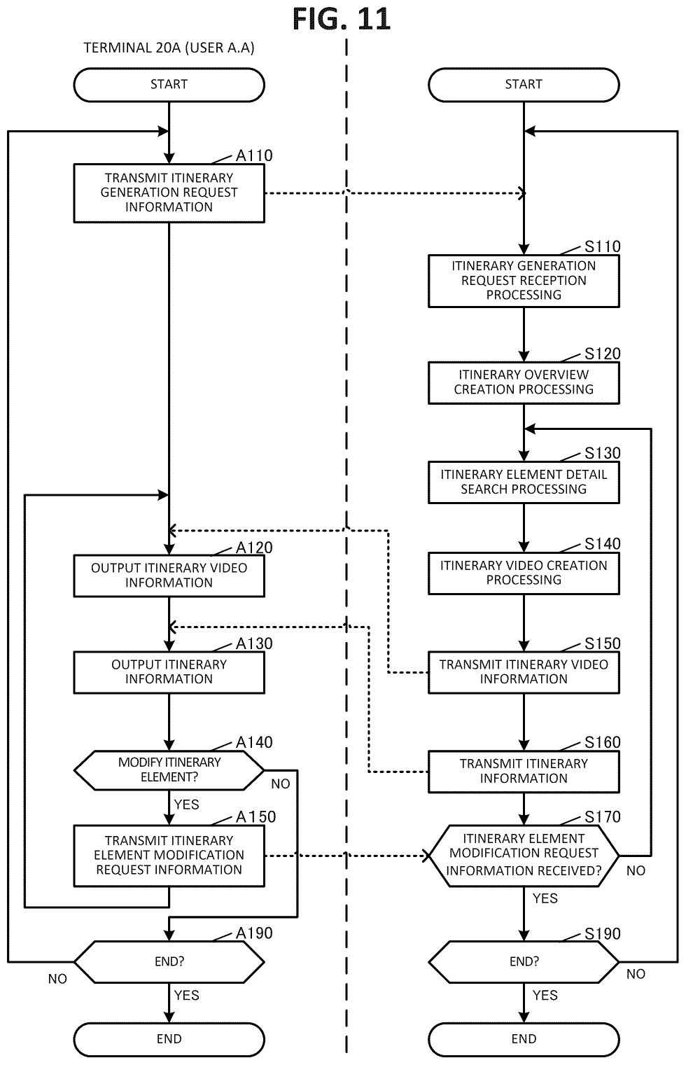

FIG. 11 is a flowchart showing an example flow of processing performed by each device in this example. In this figure, an example of processing performed by the controller 21 of the terminal 20A of the user A.A is shown in the left diagram of the flowchart, and an example of processing performed by the controller 11 of the server 10 is shown in the right diagram.

Note that the processing described below is merely an example of processing for implementing a method according to an example embodiment of the present disclosure, and example embodiments of the present disclosure are not limited to this processing.

Further, another step may be added to the following processing, or some steps may be omitted (deleted) from the following processing.

First, for example, the controller 21 of the terminal 20A transmits itinerary generation request information for generating an itinerary to the server 10 based on input to the input/output device 23 of the terminal 20A (e.g., user input such as operation input or sound input by the user; the same may apply hereinafter) (A110).

Note that the itinerary generation request information may be, for example, a character string in a natural language, such as “create a travel plan”. In some example embodiments, the itinerary generation request information may be, for example, a command of an API in the travel plan creation assistance service.

The itinerary generation request information may include, for example, general information regarding travel destinations (places), information regarding the length of stay (“two days and one night”, etc.), information regarding the dates (“next weekend”, “from December 23 to December 26”, etc.), and/or information regarding a purpose of the travel.

A means for inputting the itinerary generation request information may be, for example, as follows:
message posting to a talk room in the messaging service;
an operation of an itinerary generation button or input to a selection menu (form) from a talk room menu in the messaging service;
text input (interactive instruction) in the travel plan creation assistance application; and
input to a selection menu (form) in the travel plan creation assistance application.

Upon receiving the itinerary generation request information from the terminal 20A, the controller 11 of the server 10 performs itinerary generation request reception processing (S110).

In the itinerary generation request reception processing, the controller 11 of the server 10 determines whether an instruction to create an itinerary has been given, using, for example, a question answering model (not shown).

For example, if, in the itinerary generation request reception processing, the itinerary creation request information does not include information regarding a travel destination, dates, or the like, the controller 11 of the server 10 may transmit itinerary check information to the terminal 20A to check the travel destination, dates, or the like. For example, upon receiving the itinerary check information, the controller 21 of the terminal 20A may cause the display 24 to display the received itinerary check information.

The controller 21 of the terminal 20A may also transmit itinerary designation information regarding a travel destination, dates, or the like to the server 10 based on a user input with respect to the itinerary check information.

If, for example, it is determined that an instruction to create an itinerary has been given, the controller 11 of the server 10 performs itinerary overview creation processing (S120).

In the itinerary overview creation processing, the controller 11 of the server 10 creates itinerary overview information based on the content of instructions in the itinerary generation request information and the itinerary designation information, by using, for example, a question answering model (e.g., a closed-book question answering system). In other words, the controller 11 of the server 10 creates itinerary overview information based on the content of instructions in the itinerary generation request information and the itinerary designation information, without using a separate information database (not shown) as external knowledge (passage). Thus, the itinerary overview information could be created using a closed-book question answering system relatively quickly without performing a relatively complex computation and/or with communication with external resources.

In the processing for creating the itinerary overview information, for example, if the controller 11 of the server 10 receives a character string “I want to go to Okinawa, so make a travel plan” as the itinerary creation request information and a character string “Make it two days and one night” as the itinerary designation information, the controller 11 may separate the itinerary creation request information and the itinerary designation information with a punctuation mark, and input to the question answering model a first prompt “I want to go to Okinawa, so make a travel plan. Make it two days and one night”. Note that the itinerary designation information need not necessarily be used.

Furthermore, in the processing for creating the itinerary overview information, for example, if the controller 11 of the server 10 receives a selection menu item “Make a travel plan” as the itinerary generation request information and selection menu items “Region: Okinawa” and “Length of stay: Two days and one night” as the itinerary designation information, the controller 11 may input a first prompt into the question-answering model by separating, with punctuation marks, the character string “Please generate a travel plan”, which is a character string associated with the selection menu item “Make a travel plan”, as the itinerary generation request information, a character string “Please make Okinawa the destination,” which is a character string associated with a selection menu item “Region: Okinawa” and a character string “Please make the length of stay two days and one night,” which is a character string associated with the selection menu item “Length of stay: two days and one night”, as the itinerary designation information. Note that the itinerary designation information need not necessarily be used.

The itinerary overview information may include, for example, the following elements:
a departure location (e.g., a station, an airport, etc. to be an arrival location in an outward trip);
a place to visit (e.g., the name, address, etc. of a facility);
a place to eat (e.g., the name of a restaurant, meal content, etc.);
an accommodation (e.g., the name, address, etc. of a hotel); and
an arrival location (e.g., a station, an airport, etc. to be a departure location in a return trip)

The first prompt may include content indicating that the output includes any of these elements. Further, the first prompt may incorporate a prompt for requesting that a more detailed schedule and costs be output.

The itinerary overview information may be, for example, a generated sentence that describes rough content of a travel plan. For example, the itinerary overview information may include, for example, a list of a departure point, a place to visit, and/or an accommodation. In some example embodiments, the itinerary overview information may include, for example, information regarding a rough schedule, estimated costs, or the like.

For example, upon the itinerary overview information being created, the controller 11 of the server 10 executes itinerary element detail search processing (e.g., detailed search processing for the itinerary element) (S130).

In the itinerary element detail search processing, the controller 11 of the server 10 creates itinerary information, which is a feasible travel plan based on the itinerary overview information by using, for example, a question answering model (e.g., an open-book question answering system) with a travel information database (not shown) as external knowledge (passage).

The travel information database may be able to store various types of information, such as guide information regarding sightseeing spots (e.g., desired sightseeing time and/or fees, URLs of sightseeing facility websites, etc.), information regarding route and desired time, map information, restaurant reservation information, hotel rates and availability information, and/or weather forecasts.

In the itinerary element detail search processing, for example, the controller 11 of the server 10 may input, to the question-answering model, a second prompt to make a request to search for feasible routes and/or accommodations available for stay on the planned dates of stay, using, as a draft, the departure location, place to visit, and accommodation output as the itinerary summary information. Then, itinerary information, which is an output sentence of the question answering model, may be generated. The itinerary information may include any element related to the aforementioned itinerary.

The itinerary element detail search processing can eliminate an unfeasible travel plan generated due to hallucination of a language model.

Further, this processing can be implemented by a closed-book question answering system. The itinerary overview information can be generated efficiently by separating the itinerary overview creation processing, which uses relatively few resources, from the itinerary element detail search processing. Then, the itinerary element detail search processing is executed based on the generated itinerary overview information, and itinerary information is generated in which the itinerary overview information is refined in line with reality. Thus, a prompt length can be kept short in the itinerary element detail search processing, which tends to use a relatively large amount of access to external resources.

Note that the itinerary element detail search processing is not limited to using a question answering model. For example, the controller 11 of the server 10 may reference the travel information database based on the departure location, the place to visit, and so on in the itinerary overview information, as well as the schedule, and search for a feasible journey by dynamic programming (DP). Then, a retrieved journey may be output as the itinerary information.

Further, the itinerary overview creation processing and the itinerary element detail search processing need not necessarily be explicitly distinguished from each other. For example, the controller 11 of the server 10 may create the itinerary information by referencing the travel information database and performing the same processing as the itinerary overview creation processing.

Upon the itinerary information being created, the controller 11 of the server 10 performs itinerary video creation processing (S140).

In the itinerary video creation processing, the controller 11 of the server 10 performs, for example, section part determination processing, caption generation processing, moving image material preparation processing, and/or moving image material editing processing.

In the section part determination processing, the controller 11 of the server 10 determines, for example, the number of sections of the itinerary video and the content of scenes associated with the sections based on the itinerary information. For example, the controller 11 of the server 10 may input, to the question answering model, a prompt such as “Please divide the content included in the following itinerary into ‘N’ items. Please associate the divided content items with the overview of the itinerary. ##<<itinerary information>>” (the created itinerary information is input as <<itinerary information>>). Here, the number “N” of sections of the itinerary video may be, for example, a number instructed by the user or a number desired (or alternatively, predetermined) by the system (e.g., “N=9”). In some example embodiments, the number “N” of sections of the itinerary video may be set to an appropriate number by the question and answer model.

The number of sections (the number of scenes) may vary depending on the duration of the itinerary based on the generated itinerary information. For example, the number “N” of sections of the itinerary video may be determined such that the number of sections (e.g., 20) in the case of a six-day, five-night itinerary is greater than the number of sections (e.g., 4) in the case of a two-day, one-night itinerary. Here, the length of the itinerary video generated varies depending on the determined number of sections (the number of scenes corresponding to the sections). Thus, the control for determining the number of sections based on the duration of the itinerary is an example of control for determining the length of the itinerary video based on the duration of the itinerary.

After the number of sections of the itinerary video and the content (itinerary element) of the itinerary information corresponding to each scene are determined in the section part determination processing, the controller 11 of the server 10 performs caption generation processing, for example.

In the caption generation processing, for example, the controller 11 of the server 10 inputs, to the question answering model, a prompt such as “Consider a catchphrase that matches <<itinerary element>>” (the created itinerary element is input as <<itinerary element>>) for each scene of the itinerary video, and generates a catchphrase (e.g., “the island closest to heaven”) for each scene in the itinerary video. Note that, in the caption generation processing, for example, the controller 11 of the server 10 may input, to the question answering model, a prompt such as “Think of a caption based on the facts corresponding to the content of <<itinerary element>>” for each scene of the itinerary video, and generate a caption (e.g., “3 hours by airplane from Tokyo”) for each scene of the itinerary video.

The catchphrase and caption generated by the caption generating processing may be collectively referred to as “scene text”.

Note that the controller 11 of the server 10 may perform caption generation processing for all scenes. In some example embodiments, the controller 11 of the server 10 may perform caption generation processing on some of the scenes. Further, the controller 11 of the server 10 may be configured not to perform caption generation processing. That is, scene text may be given to any of the scenes in the itinerary video.

For example, upon the caption generation processing being performed, the controller 11 of the server 10 performs moving image material preparation processing. In the moving image material preparation processing, the controller 11 of the server 10 searches for a moving image suitable for each scene of the itinerary video using a moving image search engine (not shown), based on the itinerary element and/or the scene text corresponding to the scene.

The moving images may be, for example, searched for in a moving image database that is stored in advance in the storage 15 of the server 10. In some example embodiments, the moving images may be, for example, searched for in any image database on the Internet. In some example embodiments, the moving images may be, for example, searched for on a server of an image stock service that partners with the operator of the server 10. In some example embodiments, the moving images to be searched for may also be user-generated content (UGC) posted by users to a video sharing service or the like.

The moving image material preparation processing for searching for moving images may also be referred to as “moving image material search processing”, for example.

Note that, in the moving image material preparation processing, for example, the controller 11 of the server 10 may generate, for each scene of the itinerary video, one or more still images based on the itinerary element and/or the scene text corresponding to the scene, and generate a moving image based on the generated still images. Further, in the moving image material preparation processing, for example, the controller 11 of the server 10 may directly generate, for each scene of the itinerary video, a moving image based on the itinerary element and/or the scene text corresponding to the scene. The moving images may be generated using, for example, a moving image generation model such as Sora, Make-A-Video, or Imagen.

The moving image material preparation processing for generating a moving image may be referred to as “moving image material generation processing”, for example.

For example, when the scene text includes a phrase “make friends with a sea turtle”, a moving image may be selected as a material from UGC posted concerning a sea turtle tour in the moving image material search processing.

Further, for example, when the scene text includes a phrase “the island closest to heaven”, a moving image in which characters “heaven” are drawn on a beach may be generated as a material in the moving image material generation processing.

For example, after the moving image material preparation processing is performed, the controller 11 of the server 10 performs moving image material editing processing.

In the moving image material editing processing, for example, the controller 11 of the server 10 connects the retrieved or generated videos for respective parts. Then, for example, color or tone conversion (e.g., LUT conversion) is performed on the connected videos to generate an itinerary video.

Note that, in the moving image material editing processing, for example, the controller 11 of the server 10 may render, for each scene of the itinerary video, a character string of the scene text corresponding to the scene as an image (caption) in the moving image, and overlay the caption on the moving image.

For example, in the moving image material editing processing, the controller 11 of the server 10 may also perform background music search processing or background music generation processing.

In the background music search processing, for example, the controller 11 of the server 10 may input, to the question answering model, a prompt “Please search for background music that matches the content items included in the following itinerary. ##<<itinerary information>>”, determines a music track to be used as the background music for the itinerary video, and download the sound source, thereby combining the music track as a sound track on the itinerary video.

Further, in the background music generation processing, for example, the controller 11 of the server 10 may input a prompt “Please create background music that matches the content items included in the following itinerary. ##<<itinerary information>>” using a music generation model, such as Jukedeck or SOUNDRAW, generate a music track to be used as the background music for the itinerary video, and combine the music track as a sound track on the itinerary video.

For example, upon the itinerary video being created (generated), the controller 11 of the server 10 transmits itinerary video information, which includes the itinerary video, to the terminal 20A (S150). The itinerary video information may include, for example, the itinerary video edited in the moving image material editing processing, information regarding the time at which the moving image materials are connected in the itinerary video (which may also be referred to as chapter information), and information regarding itinerary overview information corresponding to each moving image material (e.g., information regarding a place to visit corresponding to the moving image material). Note that the itinerary video information may also include, for example, scene text corresponding to each scene.

Upon receiving the itinerary video information, the controller 21 of the terminal 20A outputs the received itinerary video information (e.g., causes the display 24 to output display and/or causes the sound output device 26 to output sound) (A120). The itinerary video information is displayed on the terminal 20A, in a talk room in which the user of the terminal 20A participates. That is, the control performed by the controller 11 of the server 10 to transmit the itinerary video information to the terminal 20A is an example of control for displaying the itinerary video information in the talk room in which the user A.A of the terminal 20A participates.

For example, after transmitting the itinerary video information, the controller 11 of the server 10 transmits the itinerary information to the terminal 20A (S160).

In some example embodiments, the controller 11 of the server 10 may be configured not to transmit the itinerary information to the terminal 20A. That is, only the itinerary video information, out of the itinerary information and the itinerary video information, may be transmitted to the terminal 20A.

Upon receiving the itinerary information, the controller 21 of the terminal 20A outputs the received itinerary information (e.g., causes the display 24 to output display) (A130). The itinerary information is displayed on the terminal 20A as a content item related to the itinerary video information in the talk room in which the user of the terminal 20A participates, after the itinerary video information. That is, the control performed by the controller 11 of the server 10 to transmit the itinerary information to the terminal 20A is an example of control for displaying the itinerary information in the talk room in which the user A.A of the terminal 20A participates.

Here, the itinerary information may be displayed after at least a part (e.g., one minute out of a total of three minutes, or three minutes out of a total of three minutes) of the itinerary video information has been output on the terminal 20A. For example, it is possible that the controller 21 of the terminal 20A makes a request for itinerary information to the server 10 based on at least a part of the itinerary video information having been output, the server 10 transmits the itinerary information to the terminal 20A in response to the request, and the terminal 20A causes the received itinerary information to be displayed as a content item following the itinerary video information.

In some example embodiments, regarding the itinerary video information and the itinerary information received from the server 10, the controller 21 of the terminal 20A may execute control to additionally display the received itinerary information based on at least a part of the previously displayed itinerary video information having been output. The controller 11 of the server 10 may transmit an instruction to cause the terminal 20A to display the received itinerary information in response to detecting that at least a part of the itinerary video information has been output in the talk room in which the user A.A of the terminal 20A participates. In response to this instruction, the terminal 20A may cause the received itinerary information to be additionally displayed.

Note that the order of output is not limited to this. The controller 21 of the terminal 20A may start outputting the itinerary video information after causing the itinerary information to be displayed. For example, the server 10 may first transmit the itinerary information to the terminal 20A, and then transmit the itinerary video information (e.g., first cause the itinerary information to be displayed in the talk room, and then cause the itinerary video information to be displayed).

If, for example, it is determined, based on a user input with respect to the displayed itinerary information, that a modification of an itinerary element has been selected (A140: YES), the terminal 20A obtains itinerary element modification request information according to an instruction given by the user, and transmits it to server 10 (A150).

In some example embodiments, the itinerary element modification request information may be one command of the API based on an operation performed for the itinerary information, or may be modification instruction text or modification instruction voice input in a natural language.

As with CT3 displayed in FIG. 10, an element may be added to the video and the travel plan upon receiving an instruction to add the element in the form of modification instruction text. Further, an element may be deleted from the video and the travel plan upon receiving an instruction to delete the element. It is conceivable that the user who has viewed the video grasps the atmosphere of the entire travel and gives an instruction such as “I would prefer a bit more relaxing trip”. To address such an instruction, the video and the travel plan may be modified using a generative model such as GPT-4.

Thereafter, for example, the terminal 20A returns the processing to wait for receiving the itinerary video information again.

If it is determined that non-modification of the itinerary elements is selected (140: NO), for example, the terminal 20A determines whether to end the processing (A190).

If it is determined that the processing continues (A190: NO), for example, the controller 21 of the terminal 20A returns the processing to A110. On the other hand, if it is determined that the processing ends (A190: YES), the controller 21 of the terminal 20A ends the processing.

If it is determined that the itinerary element modification request information has been received from the terminal 20A (S170: YES), for example, the server 10 creates itinerary overview information reflecting a part or all of the change in the itinerary element based on the itinerary element modification request information, and again performs the itinerary element detail search processing (S130). That is, the server 10 generates the itinerary information reflecting the change in the itinerary element, performs the itinerary video creation processing based on the generated itinerary information, transmits the changed itinerary video information to the terminal 20A, and transmits the changed itinerary information to the terminal 20A. Display control for the changed itinerary video information and the changed itinerary information is the same as the above-described display control for the itinerary video information before the change and the itinerary information before the change.

Thus, thumbnails of the itinerary video content before and after the modification are selectably displayed on the terminal 20A (see FIG. 10), and both content items can be played back in accordance with a user operation.

If, for example, an itinerary element is significantly changed in the itinerary element modification request information (e.g., a change in the travel destination itself), the server 10 may return the processing to the itinerary overview creation processing. Then, the itinerary overview information may be created based on the itinerary element modification request information.

If it is determined that no itinerary element modification request information is received (S170: NO), for example, the server 10 determines whether to end the processing (S190).

If it is determined that the processing continues (S190: NO), for example, the controller 11 of the server 10 waits for receiving itinerary generation request information and returns the processing to S110. On the other hand, if it is determined that the processing ends (S190: YES), the controller 11 of the server 10 ends the processing.

### Effects of First Example Embodiment

According to this example embodiment, the server 10 (an example of a server) that communicates with the terminal 20 (an example of a terminal) generates itinerary information (an example of a first itinerary) based on itinerary generation request information (an example of first information) that is input to the terminal by the user. Further, in the above-described example configuration, the controller of the server performs itinerary video generation processing for generating itinerary video information (an example of a first video) regarding the first itinerary, based on the first itinerary, and transmits the first video to the terminal.

This makes it possible to provide the first video to the user, and the user can understand the information on the places they want to visit with reference to the first video.

Further, according to this example embodiment, the controller can transmit the first itinerary to the terminal, thereby enabling the user to view the first video and check the first itinerary provided.

Further, according to this example embodiment, the controller can execute control to display the first itinerary on the terminal after the first video is played back. This enables the user to understand the overview of first itinerary in more detail through the first video and then to check the first video.

According to this example embodiment, the first video includes a plurality of scenes. The controller can generate scene text (an example of text corresponding to a scene) in the caption generation processing, and can overlay the text on the scene in the moving image material editing processing. This enables the text describing the scene abstractly and concisely to be presented to the user.

According to this example embodiment, the first video includes a plurality of scenes. In the caption generation processing, the controller can generate scene text (an example of text corresponding to a scene), and transmit the text to the terminal. This enables the text to be displayed on the terminal at any position and in any mode, in correspondence with the scene.

According to this example embodiment, in the background music generation processing, the controller can generate background music for the first video and combine the background music with the first video, and can transmit the first video with the background music combined to the terminal. This enables the user to grasp the impression of the first itinerary multimodally.

Further, in the above-described example configuration, the controller of the server generates new itinerary information (an example of a second itinerary) based on itinerary element modification request information (an example of modification information for the first information that is input to the terminal by the user). Further, the controller of the server performs itinerary video generation processing for generating itinerary video information regarding the second itinerary (an example of a second video), based on the second itinerary, and transmits the second video to the terminal.

This enables the server to generate the second itinerary based on the first information and the modification information that are input to the terminal by the user, and the second video related to the second itinerary, and to transmit the second video to the terminal. When the user wants to view a video based on an itinerary different from the first itinerary, the user can be provided with the second video related to the second itinerary that is obtained by modifying the first itinerary using the modification information.

In the above-described example configuration, the first video can be played back on the terminal even after the second video has been played back on the terminal, as shown in FIG. 10.

This enables the user of the terminal to easily view the first video again even after the second video has been provided, and to compare the first and second videos.

In the above-described example configuration, the server causing the controller to control information to be displayed in the talk room displayed on the terminal and transmit the first video to the terminal includes executing control to display the first video in the talk room.

This enables the user to easily reference the first video in the talk room.

### First Variation of the First Example Embodiment

In the moving image material preparation processing in the above example, a moving image suitable for a scene is searched for based on an itinerary element and/or scene text corresponding to the scene, or a moving image is generated using a video generation model. However, there is no limitation to this configuration. For example, an open-book question answering system using retrieval-augmented generation (RAG) may search for and generate a moving image based on a prompt that includes an itinerary element and/or scene text corresponding to a scene.

For example, in order to search for a still image, an image search engine is used to search for related images based on a query of a user. When, for example, “landscape photograph” is input as a query, an image related to a landscape photograph is retrieved.

To incorporate the retrieved image into the generation process, the content of the image may be converted into text and supplied to the generation model by using image caption generation and a technique of extracting features from the image.

For example, in order to search for a video, a specific frame or scene is searched for by using a video search engine, and the search is performed using metadata or a caption of videos. It is also possible to extract a specific scene from a video and convert the content thereof into text such that it can be used in RAG generation process. Similarly, audio data or caption data of a video may also be used for the search.

For example, Contrastive Language-Image Pre-training (CLIP) or Bootstrapping Language-Image Pre-training (BLIP) may be used to extend the RAG using a multimodal model of images and languages. The search and generation may be performed by thereby linking text and images.

### Second Variation of the First Example Embodiment

In the above-described example configuration, one itinerary is presented as the itinerary video information or itinerary information in response to one piece of itinerary generation request information. However, there is no limitation to this configuration. For example, it is possible to enable the user to select any itinerary information by generating and presenting not only one itinerary, but also a plurality of pieces of itinerary video information and itinerary information. For example, the user may reference a plurality of pieces of itinerary video information, and the terminal 20A may output only the itinerary information corresponding to the selected piece of itinerary video information.

Note that the itinerary information may also include information on transportation facilities or the like. For example, in the itinerary element detail search processing, the server 10 may perform optimization (or may refine) so as to satisfy geographical temporal constraints.

### Third Variation of the First Example Embodiment

In the above example, the server 10 performs the itinerary overview creation processing, the itinerary element detail search processing, and the itinerary video creation processing. However, there is no limitation to this configuration. For example, the processing may be performed in a server system that is constituted by or includes an interaction reception server 10L, a travel information server 10T, and a video generation server 10V.

For example, upon performing the itinerary generation request reception processing and the itinerary overview creation processing, the interaction reception server 10L may transmit, to the travel information server 10T, itinerary element detail inquiry information for creating a more specific itinerary based on the itinerary overview information. The travel information server 10T may then perform the itinerary element detail search processing based on the itinerary element detail inquiry information. The travel information server 10T may then transmit itinerary element detailed information (e.g., detailed information of itinerary element) including the retrieved itinerary element to the interaction reception server 10L.

Upon receiving the itinerary element detailed information from the travel information server 10T, for example, the interaction reception server 10L may convert the itinerary element detailed information into a displayable format, and transmit the converted itinerary information to the terminal 20A. Further, the interaction reception server 10L may also transmit the itinerary element detailed information to the video generation server 10V.

The video generation server 10V may perform the itinerary video creation processing based on the itinerary element detailed information. The itinerary video information including the generated itinerary video may then be transmitted to the interaction reception server 10L. Then, the interaction reception server 10L may transmit the itinerary video information to the terminal 20A.

### Fourth Variation of the First Example Embodiment

In the above example, the server 10 creates an itinerary and an itinerary video based on the received itinerary generation request information. However, there is no limitation to this configuration. For example, the server 10 may perform the itinerary video creation processing again based on the reception of an already created itinerary, based on the itinerary video regeneration request information received from the terminal 20. The server 10 may then transmit the regenerated itinerary video information to the terminal 20. This makes it possible to create a first itinerary video and a second itinerary video based on the first itinerary when, for example, the user wants to know more about the itinerary or when the user is satisfied with the itinerary itself but is dissatisfied with the itinerary video. This enables the user to create and share an itinerary video that matches the preferences of the user when, for example, sharing the itinerary video with friends or the like.

According to this variation, the controller of the server can generate the second video related to the first itinerary, based on the first itinerary, and transmit the second video to the terminal. The user of the terminal can thereby reference the second video different from the first video generated based on the first itinerary.

### Fifth Variation of the First Example Embodiment

In the moving image material preparation processing in the above example, a moving image suitable for a scene of the itinerary video is searched for or generated based on the itinerary. However, there is no limitation to this configuration. For example, in the moving image material preparation processing, some or all of the scenes of the itinerary video may be advertisement images.

For example, in the moving image material preparation processing, the server 10 may search for an advertisement image from an advertisement server (not shown) based on an itinerary element and/or scene text corresponding to the scene, and select the matched advertisement image as a scene. Note that, in the case of inserting an advertisement image as a scene, the server 10 may overlay text such as “This video contains an advertisement” on the itinerary video in the moving image material editing processing.

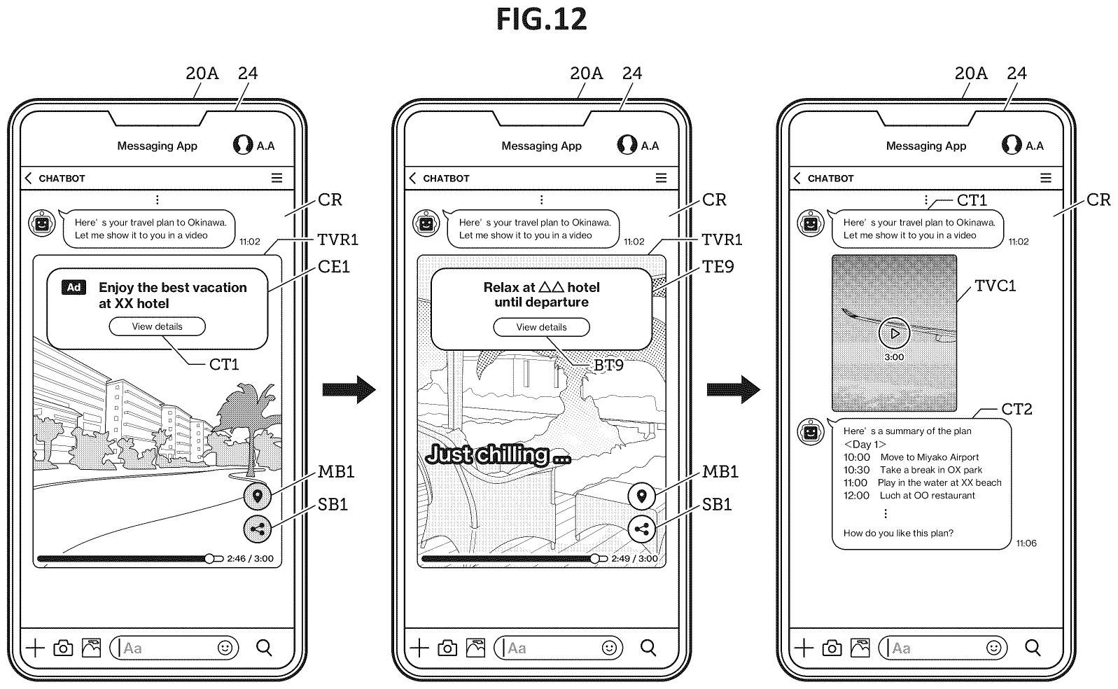

FIG. 12 shows examples of display screens according to an example embodiment of the fifth variation.

A left diagram in FIG. 12 shows a screen in which a scene advertising “XX Hotel” is displayed, which is incorporated before the last scene of the itinerary video in the itinerary video information display area TVR1. On this screen, for example, a video advertising “XX hotel”, which is selected based on an itinerary element of the hotel that appears in the next scene, is displayed. Further, an advertisement scene title display area CE1, which indicates that this scene is an advertisement, is displayed in place of the video scene title display area. A detailed information display button CT1, which enables the user to check detailed information on the advertisement, is displayed on the lower side of the advertisement scene title display area CE1.

For example, while the advertisement scene is displayed, the share button SB1 and the map display button MB1 may be grayed out such that the functions of these buttons are disabled. That is, the user may be disabled from skipping the advertisement to confirm or share the itinerary while viewing the advertisement scene. For example, while the advertisement scene is displayed, the seek bar operation in the itinerary video information display area TVR1 may be disabled so as to disable skipping of the advertisement scene, for example.

For example, after the playback of the advertisement scene ends, the playback of the scene corresponding to the last plan of the itinerary shown in a center diagram in FIG. 12 starts. Then, as shown in a right diagram in FIG. 12, a continuation of the talk room screen that is displayed when the playback of the itinerary video ends is displayed in the itinerary video information display area TVR1. That is, the itinerary information CT2 is displayed in the talk room after the itinerary video content item TVC1, which is a thumbnail of the itinerary video information display area TVR1. That is, the itinerary information is displayed based on the completion of the playback of the entire itinerary video including the advertisement scene.

In some example embodiments, when the user skips the advertisement scene by, for example, operating the seek bar in the left diagram in FIG. 12, the itinerary information CT2 may be configured not to be displayed in the right diagram of FIG. 12. That is, viewing of the advertisement scene is desired to reference the itinerary information. In this case, for example, upon detecting an end of the playback of the advertisement scene, the controller 21 of the terminal 20 may transmit advertisement playback end information to the server 10. If it is determined that the advertisement playback end information has been received from the terminal 20, the controller 11 of the server 10 may transmit the itinerary information to the terminal 20. That is, upon completion of the playback of the advertisement scene, the itinerary information may be displayed without waiting for an end of the playback of the entire itinerary video.

In the configuration described in the present variation, the first video includes a plurality of scenes, at least one of the scenes is an advertisement video, and the controller executes control to cause the terminal to display the first itinerary after the advertisement video has been played back on the terminal. This enables the first itinerary to be displayed on the terminal after the advertisement video has been played back, thereby improving the viewing probability for the advertisement video and/or enhancing the advertising effect.

Here, the number of advertisements (the number of advertisement scenes) included in the first video is not limited to one, and may be more than one. For example, in the case where the number of sections (the number of scenes) varies depending on the duration of the itinerary based on the generated itinerary information as mentioned above, the number of advertisements may be determined in accordance with the number of sections. For example, the number of advertisements (e.g., 5) corresponding to the number of sections (e.g., 20) for a six-day, five-night itinerary may be greater than the number of advertisements (e.g., 1) corresponding to the number of sections (e.g., 4) for a two-day, one-night itinerary. Here, the length of the generated itinerary video varies depending on the determined number of sections (the number of scenes corresponding thereto). Therefore, control for determining the number of sections based on the duration of the itinerary is an example of control for determining the number of advertisements based on the duration of the itinerary.

If the first video contains multiple (e.g., 5) advertisements, the itinerary information may be displayed based on the playback of all (5) of the advertisement scenes having been finished, or based on the playback of a desired (or alternatively, predetermined) number (e.g., 3) of the advertisement scenes having been finished, rather than the playback of all of them having been finished.

### Other Examples

In the above-described examples, the interaction in the messaging service is one-on-one interaction between one user and a chatbot. However, there is no limitation to this configuration. For example, a talk room may be created in which two or more users and a chatbot participate (a talk room including accounts of these users and an account of the chatbot). In this case, the generated video and travel plan are shared between the two or more users at the same time, which is convenient when two or more users are making a travel plan.

In addition, when a video and a travel plan are generated through one-on-one interaction, the user may be enabled to transfer the video and the travel plan to another talk room in which the user and their friend participate (e.g., another talk room including accounts of these users). For example, a video may be shared with another talk room designated by the user by operating the aforementioned share button SB1 or SB2. Further, when an operation for sharing a video with another talk room is received, a travel plan may be (automatically) shared with the other talk room.

That is, when the generated first video and first itinerary are displayed in a first talk room in which a first user of a first terminal and a chatbot participate (and in which a second user of a second terminal does not participate), the first video and the first itinerary may be displayed in (transferred to) a second talk room in which the first user and the second user participate, based on a transfer operation performed by the first user in the first talk room on the first terminal. At this time, the server 10 executes control to display the first video and the first itinerary in the second talk room (e.g., transmits the first video and the first itinerary to the first and second terminals to display them in the second talk room) based on the transfer operation performed by the first user.

Furthermore, in the second talk room that is the transfer destination, similar to the first talk room, the screen may transition to a reservation screen where a service facility can be reserved, in response to tapping on the displayed video or travel plan. For example, the second talk room may be on the same social media platform (first social media platform) as the first talk room, or on a social media platform (second social media platform) different from the first talk room, as described below.

Note that, by operating the share button SB1 or SB2, a video and a travel plan may be shared with a social media platform (second social media platform) as a transfer destination that is different from the social media platform (first social media platform) providing the messaging service that uses the relevant chat room. On the social media platform (second social media platform) that is the transfer destination, another user who has viewed the video and the travel plan may also be enabled to reserve a service (food and beverage service, accommodation service, etc.) facility included in the travel plan by tapping the displayed video or travel plan to input information for the reservation. In this case, on the social media platform (first social media platform) that is the transfer source, the screen may be able to transition to a reservation screen associated with the first social media platform (e.g., a reservation screen for a first accommodation service linked with the first social media platform) by tapping the video or travel plan displayed on the first social media platform. Here, on the social media platform (second social media platform) that is the transfer destination, the screen may be able to transition to a reservation screen associated with the second social media platform (e.g., a reservation screen for a second accommodation service linked with the second social media platform) by tapping the video or travel plan displayed on the second social media platform.

That is, the controller 11 of the server 10 may transmit, to the first terminal of the first user, first reservation screen information on a first reservation service linked to the first social media platform, which enables reservation of service facilities included in the video or the itinerary displayed on the first social media platform, by making an input regarding the video or the itinerary. Then, processing for reserving a service facility may be performed based on the input made by the first user with respect to the first reservation screen information.

Then, the controller 11 of the server 10 may perform control to share, with the second social media platform, the video or the itinerary that has been shared on the first social media platform, based on a transfer operation performed by the first user on the first social media platform. For example, on the second social media platform, a video or an itinerary is published in association with an account of the first user for the second social media platform, and an input with respect to the published video or itinerary is made on a second terminal of a second user who has viewed the video or itinerary. In response to this, the controller 11 may transmit, to the second terminal, a second reservation screen information on a second reservation service linked with the second social media platform, which enables reservation of service facilities included in the video or the itinerary. Then, processing for reserving a service facility may be performed based on the input made by the second user with respect to the second reservation screen information on the second terminal.

A configuration is also possible in which, for multiple videos published by the account of a first user on a second social media platform, a selection operation such as “like” or “dislike” (which may be implemented by a means on a UI that can be selected by a swiping operation on the application, but is not limited thereto) is received from a second terminal of a second user who is viewing the videos, a new video and travel plan are generated based on the selection results, and the regenerated video and travel plan are shared in association with the account of the second user on the second social media platform. Then, users (including a first user and a second user) who can view the video and the itinerary on the second social media platform may be enabled to reserve a service facility by performing an input operation with respect to the regenerated video and travel plan.

Further, when a second user different from the first user who has performed a transfer operation performs an operation to modify the video or the travel plan on the second social media platform that is the transfer destination, the video or the travel plan that is the modification target may be modified on the second social media platform that is the transfer destination. For example, in order to enable this modification, an account of a chatbot may be added to a second talk room on the second social media platform with which the video or travel plan has been shared, automatically or in accordance with permission given by a user of another account in the second talk room.

The terminal 20 may perform at least part of the processing that is performed by the server 10 in the above-described examples. Conversely, the server 10 may perform at least part of the processing that is performed by the terminal 20 in the above examples.

The operator of the server 10 may also be an image generation service provider that partners with the messaging service provider.

In this case, the processing described in the above examples may be implemented by a single server or distributed in a server system constituted by or including a plurality of servers.

Note that, for example, a system constituted by or including one or more servers may be defined as a server system, and the server of an example embodiment of the present disclosure may be defined as a server system.

For example, the server system may be constituted by or may include an information processing device, an image generating device, and a language generating device.

In the above examples and variations, the server for distributing various applications (the server from which the terminal 20 downloads the applications) may be a server that is different from the server or the like that provides corresponding services (e.g., applications). That is, a server for delivering the applications and a server or the like that performs application management processing or the like described in the above examples and variations may be configured as physically separated servers or as a single server.

The applications are not limited to including programs for various applications, but may also include, for example, programs that provide the functionality of another service as one function of a primary application (e.g., a program that provides the functionality of an advertisement distribution service as one function of the messaging application, or vice versa), and programs for updating the primary application. The programs may include data utilized in the application programs (including data for updating the applications, etc.).

Furthermore, in the above examples and variations, for example, a method for implementing an example embodiment of the present disclosure using a client-server system has been described, but example embodiments of the present disclosure are not limited to this. As mentioned above, the present disclosure may be implemented by a system such as a distributed system in which the terminal 20 has the functions of a server or server system. For example, the terminal may perform the processing that is described as being performed by the server or the server system according to the flow chart described in the above example (e.g., FIG. 11).

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

As described above, the content described in the above examples, variations, and other examples may be applied in combination with each other.

What is claimed is:

1. A non-transitory computer readable medium storing a program thereon, which when executed by a server configured to communicate with a terminal, causes the server to implement an information processing method, the method comprising:
generating, by a controller of the server, a first itinerary based on first information input to the terminal by a user;
generating, by the controller, a first video related to the first itinerary, based on the first itinerary; and
transmitting the first video to the terminal, by the controller.

2. The non-transitory computer readable medium storing the program according to claim 1, wherein the method further comprises:
transmitting the first itinerary to the terminal, using the controller.

3. The non-transitory computer readable medium storing the program according to claim 2, wherein the method further comprises:
causing, by the controller, the first itinerary to be displayed on the terminal after the first video has been played back on the terminal.

4. The non-transitory computer readable medium storing the program according to claim 2, wherein
the first video includes a plurality of scenes,
at least one of the plurality of scenes is an advertisement video, and
the method further comprises causing, by the controller, the first itinerary to be displayed on the terminal after the advertisement video has been played back on the terminal.

5. The non-transitory computer readable medium storing the program according to claim 1, wherein
the first video includes a plurality of scenes, and
the method further comprises
generating text corresponding to the scenes, by the controller, and
overlaying the text on the scenes, by the controller.

6. The non-transitory computer readable medium storing the program according to claim 1, wherein
the first video includes a plurality of scenes, and
the method further comprises,
generating text corresponding to the scenes, by the controller, and
transmitting the text to the terminal, by the controller.

7. The non-transitory computer readable medium storing the program according to claim 1, wherein the method further comprises:
generating background music for the first video based on the first itinerary, by the controller;
combining the background music with the first video, by the controller; and
transmitting, to the terminal, the first video with which the background music is combined, by the controller.

8. The non-transitory computer readable medium storing the program according to claim 1, wherein the method further comprises:
generating, by the controller, a second itinerary based on modification information for the first information input to the terminal by the user;
generating, by the controller, a second video related to the second itinerary, based on the second itinerary; and
transmitting the second video to the terminal, by the controller.

9. The non-transitory computer readable medium storing the program according to claim 1, wherein the method further comprises:
generating, by the controller, a second video related to the first itinerary, based on the first itinerary; and
transmitting the second video to the terminal, by the controller.

10. The non-transitory computer readable medium storing the program according to claim 8, wherein the method further comprises playing back the first video on the terminal after the second video has been played back on the terminal.

11. The non-transitory computer readable medium storing the program according to claim 1, wherein
the method further comprises causing, by the controller, to control information to be displayed in a talk room displayed on the terminal, and
the transmitting the first video to the terminal includes controlling displaying of the first video in the talk room.

12. An information processing method to be performed by a server configured to communicate with a terminal, the method comprising:
generating, by a controller of the server, a first itinerary based on first information input to the terminal by a user;
generating, by the controller, a first video related to the first itinerary, based on the first itinerary; and
transmitting the first video to the terminal.

13. A server configured to communicate with a terminal, the server comprising:
a controller configured to:
(i) generate a first itinerary based on first information input to the terminal by a user;
(ii) generate a first video related to the first itinerary, based on the first itinerary; and
(iii) transmit the first video to the terminal.
